(19) United States
(12) Patent Application Publication
(10) Pub. No.: US 2026/0260216 A1
(43) Pub. Date: Sep. 3, 2026

(54) COLLABORATIVE EXTENDED REALITY VIRTUAL ENVIRONMENTS TO FACILITATE WORKFLOWS

(71) Applicant: International Business Machines Corporation, Armonk, NY (US)

(72) Inventors: Jennifer M. HATFIELD, Portland, OR (US); Aaron Keith BAUGHMAN, Cary, NC (US); Tushar AGRAWAL, West Fargo, ND (US); Sarbajit Kumar RAKSHIT, Kolkata (IN); Vinod Anandram VALECHA, Pune (IN)

(21) Appl. No.: 19/067,831

(22) Filed: Feb. 28, 2025

(51) Int. Cl. G06Q 10/10; G06Q 10/0633; G06T 17/00

(52) U.S. Cl. CPC G06Q 10/103; G06Q 10/0633; G06T 17/00

(57) ABSTRACT

Workflow data associated with a workflow is obtained by an extended reality (XR) workflow platform. Workflow parameters associated with the workflow are determined based on the workflow data. A workflow configuration is generated based on the workflow parameters. A collaborative XR virtual environment is generated based on the workflow configuration to facilitate the workflow. The collaborative XR virtual environment comprises an XR-based communication exchange between at least two XR devices.

### BACKGROUND

The present invention relates to extended reality, and in particular to providing collaborative extended reality virtual environments to facilitate workflows.

### SUMMARY

In one embodiment, a computer-implemented method is provided. In this embodiment, the method includes obtaining, by an extended reality (XR) workflow platform, workflow data associated with a workflow. The method further includes determining, based on the workflow data, workflow parameters associated with the workflow. Additionally, the method includes generating a workflow configuration based on the workflow parameters. The method also includes generating, based on the workflow configuration, a collaborative XR virtual environment to facilitate the workflow, wherein the collaborative XR virtual environment comprises an XR-based communication exchange between at least two XR devices.

In another embodiment, a computer system is provided. In this embodiment, the computer system includes one or more computer-readable storage media, a processor set, and program instructions stored on the one or more computer-readable storage media to cause the processor set to perform operations. The operations include obtaining, by an extended reality (XR) workflow platform, workflow data associated with a workflow. The operations further include determining, based on the workflow data, workflow parameters associated with the workflow. Additionally, the operations include generating a workflow configuration based on the workflow parameters. The operations also include generating, based on the workflow configuration, a collaborative XR virtual environment to facilitate the workflow, wherein the collaborative XR virtual environment comprises an XR-based communication exchange between at least two XR devices.

In yet another embodiment, a computer program product is provided. In this embodiment, the computer program product includes one or more computer-readable storage media and program instructions stored on the one or more computer readable storage media to perform operations. The operations include obtaining, by an extended reality (XR) workflow platform, workflow data associated with a workflow. The operations further include determining, based on the workflow data, workflow parameters associated with the workflow. Additionally, the operations include generating a workflow configuration based on the workflow parameters. The operations also include generating, based on the workflow configuration, a collaborative XR virtual environment to facilitate the workflow, wherein the collaborative XR virtual environment comprises an XR-based communication exchange between at least two XR devices.

### BRIEF DESCRIPTION OF THE DRAWINGS

FIG. 1A is a block diagram of an example system for providing collaborative extended reality (XR) virtual environments to facilitate workflows, as described herein.

FIG. 1B is a block schematic diagram of an example of the system of FIG. 1A.

FIG. 1C is a block diagram of an example of the XR service component of FIG. 1A.

FIG. 2A is a flow diagram showing an example workflow, as described herein.

FIG. 2B is a flow diagram showing another example workflow, as described herein

FIGS. 3A-3D are flow diagrams of example processes associated with collaborative XR virtual environments, as described herein.

FIG. 4 is a block diagram of an example computing environment in which systems and/or methods described herein may be implemented.

FIG. 5 is a diagram of example components of one or more devices of FIG. 1.

FIG. 6 is a flowchart of an example technique for providing a collaborative XR virtual environment to facilitate a workflow, as described herein.

### DETAILED DESCRIPTION

The following detailed description of example implementations refers to the accompanying drawings. The same reference numbers in different drawings may identify the same or similar elements.

In recent years, the integration of extended reality (XR) technologies into industrial and manufacturing processes has gained traction. These technologies, which include virtual reality (VR), augmented reality (AR), and mixed reality (MR), offer solutions for remote collaboration and workflow optimization. However, the implementation of XR in complex workflow environments presents technical challenges that current systems may struggle to address effectively.

One of the technical obstacles in existing XR workflow systems is the difficulty in seamlessly integrating real-time data from various sources into the virtual environment. Traditional systems may lack the capability to dynamically incorporate data from sensors, IoT devices, and external databases in a way that is both timely and contextually relevant to the workflow at hand. This limitation may hamper the ability of users to make informed decisions based on up-to-date information, potentially leading to inefficiencies and errors in the workflow process.

Another challenge lies in the coordination and synchronization of multiple users within the XR environment, particularly when dealing with complex workflows that involve both on-site and remote participants. Current XR platforms may struggle to provide a cohesive collaborative experience that accurately represents the roles, permissions, and interactions of various users within the workflow. This can result in communication breakdowns, security vulnerabilities, and difficulties in managing the flow of information between different stages of the workflow.

Furthermore, existing XR workflow systems may lack the flexibility to adapt to changing workflow requirements or to optimize processes based on real-time performance data. The inability to dynamically reconfigure workflows or create sub-workflows can lead to rigid, inefficient processes that fail to leverage the full potential of XR technology for improving productivity and decision-making in industrial settings.

Implementations of this disclosure address problems such as these by providing an XR workflow platform that obtains workflow data, determines workflow parameters, generates a workflow configuration, and generates a collaborative XR virtual environment to facilitate the workflow. This technical solution integrates real-time data from various sources, coordinates multiple users within the XR environment, and adapts to changing workflow requirements, addressing challenges in existing XR workflow systems.

The XR workflow platform analyzes the obtained workflow data to determine workflow parameters, which may include, for example, workflow steps, dependencies among workflow steps, data processing parameters, data transfer parameters, security parameters, or automation parameters, among other examples. In some implementations, the platform may optimize the execution of workflow operations in the collaborative XR virtual environment based on these parameters. For example, the platform might adjust the sequence of steps or resource allocation to minimize bottlenecks and improve overall efficiency.

The workflow configuration generated by the platform serves as a data structure that defines how the workflow will be executed in the XR environment. This configuration may include, for example, participant assignments to specific workflow steps based on roles or access permissions. In some implementations, the configuration may divide the workflow into sub-workflows, each with its own collaborative XR virtual space. These sub-workflows can be dynamically integrated based on their dependencies, allowing for flexible and efficient workflow management. The XR workflow platform may incorporate machine learning techniques to improve workflow efficiency. By analyzing workflow execution data, the platform can identify patterns, predict potential issues, and suggest optimizations.

The collaborative XR virtual environment created by the platform enables an XR-based communication exchange between at least two XR devices. This environment may include avatars representing participants, facilitating interaction between on-site and remote users. In some implementations, the environment may include multiple collaborative XR virtual spaces, each corresponding to a specific workflow step. This structure allows for focused, context-specific collaboration while maintaining the overall workflow coherence.

The platform establishes connections with various data sources, which may include internal databases, Internet of Things (IoT) devices, sensors, or external data sources. This integration allows for real-time data incorporation into the XR environment, enabling participants to make informed decisions based on up-to-date information. For instance, in a manufacturing workflow, real-time data from production line sensors could be visualized within the XR environment, allowing remote managers to monitor and optimize processes.

To enhance communication and collaboration, the platform may establish multimodal communication connections between XR devices. These connections can support various forms of interaction, such as video, audio, text, or telemetry data exchange. In some implementations, the platform might employ natural language processing to facilitate seamless communication between participants speaking different languages or to enable voice-controlled interactions within the XR environment. In some implementations, the platform may interact with robotic components, transmitting executable instructions to automate certain workflow operations. This integration of XR and robotic systems can enhance productivity in industries such as manufacturing or logistics.

In some implementations, the XR workflow platform analyzes workflow data to determine workflow parameters and generate a workflow configuration. An advantage of the workflow analysis and configuration generation may be improved efficiency in setting up complex workflows in the XR environment. Additionally, an advantage of the workflow analysis and configuration generation may be enhanced flexibility to adapt to different types of workflows across various industries. Furthermore, an advantage of the workflow analysis and configuration generation may be the ability to optimize workflow steps based on dependencies and security considerations, leading to smoother execution of tasks in the collaborative XR environment.

In some implementations, the system generates a collaborative XR virtual environment based on the workflow configuration, enabling XR-based communication exchange between multiple XR devices. Accordingly, an advantage of the collaborative XR virtual environment may be improved remote collaboration capabilities, allowing geographically dispersed teams to work together effectively in a shared virtual space. Additionally, an advantage of the collaborative XR virtual environment may be enhanced visualization of complex workflow processes, making it easier for participants to understand and execute their tasks. Moreover, an advantage of the collaborative XR virtual environment may be the ability to integrate real-time data from various sources, providing participants with up-to-date information for informed decision-making during workflow execution.

In some implementations, the system can divide workflows into sub-workflows and generate corresponding collaborative XR virtual spaces within the main environment. Accordingly, an advantage of the sub-workflow division and space generation may be increased modularity in managing complex workflows, allowing for more efficient organization and execution of tasks. Additionally, an advantage of the sub-workflow division and space generation may be improved scalability, enabling the system to handle workflows of varying complexity and size. Furthermore, an advantage of the sub-workflow division and space generation may be enhanced flexibility in assigning different teams or individuals to specific sub-workflows, facilitating parallel processing and potentially reducing overall workflow completion time.

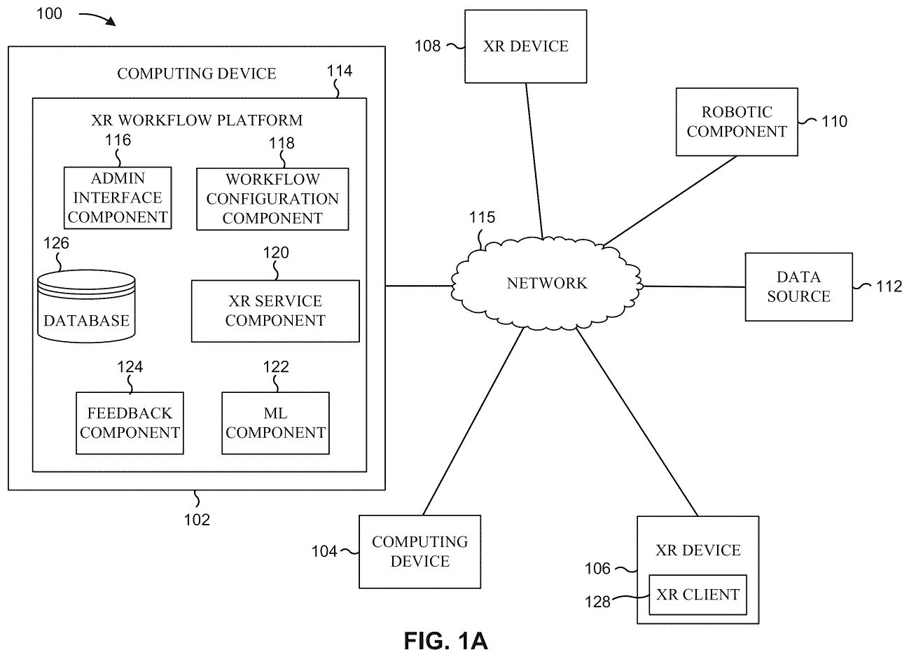

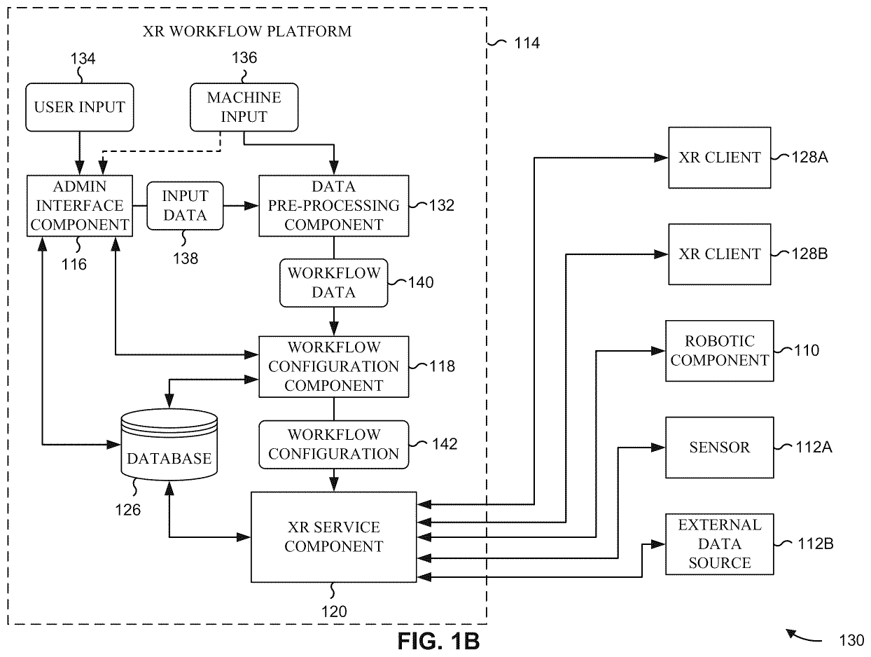

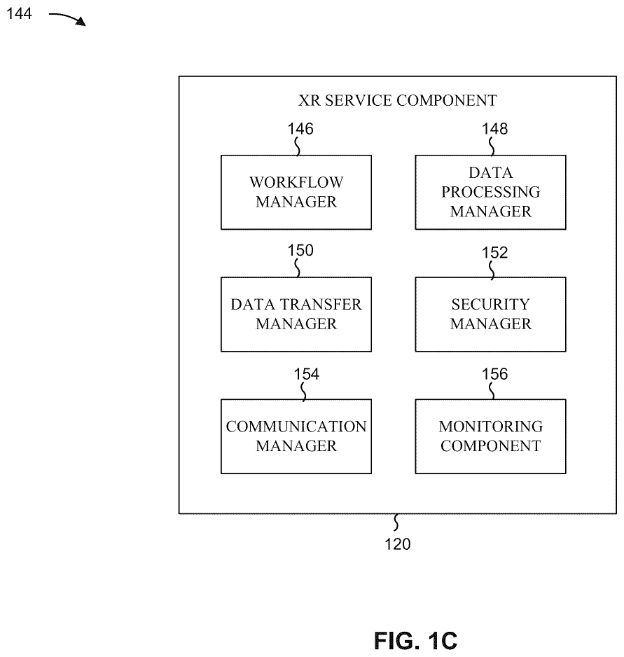

FIGS. 1A-1C are block diagrams illustrating an example system 100 for implementing an XR workflow platform, in accordance with various implementations of the present disclosure.

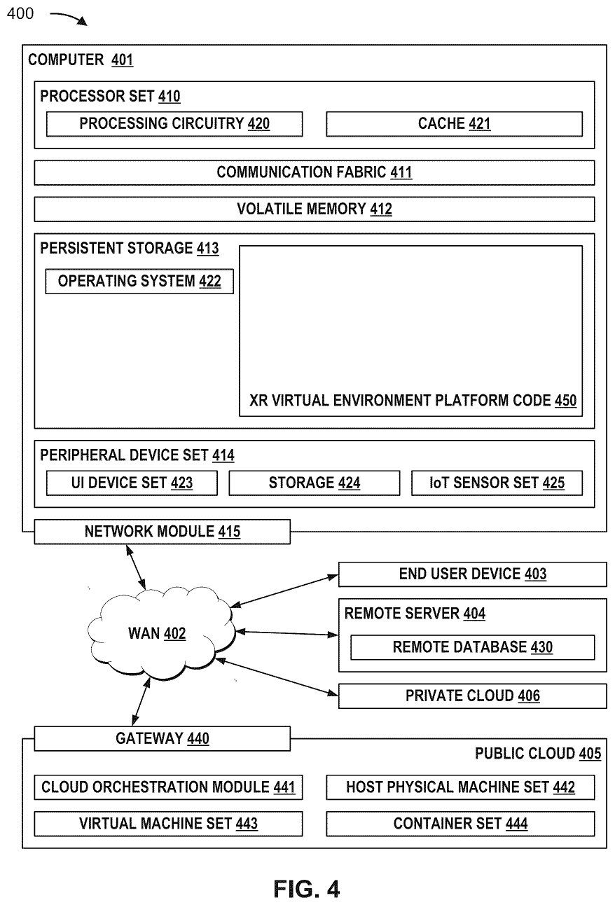

Referring to FIG. 1A, the system 100 includes a computing device 102, a computing device 104, an XR device 106, an XR device 108, a robotic component 110, and a data source 112. A network 115 communicatively connects the computing device 102, the computing device 104, the XR device 106, the XR device 108, the robotic component 110, and the data source 112 with each other. In some implementations, the system 100 may include additional or fewer components, as compared to what is illustrated in FIG. 1A. The functions of one or more of the computing device 102, the computing device 104, the XR device 106, the XR device 108, the robotic component 110, and the data source 112 may be performed by and/or distributed among multiple other devices of the system 100. One or more of the computing device 102, the computing device 104, the XR device 106, the XR device 108, the robotic component 110, and the data source 112 may operate individually and/or collectively with one or more other computing devices 102, computing devices 104, XR devices 106, XR devices 108, robotic components 110, and/or data sources 112. In some implementations, one or more of the computing device 104, the XR device 108, the robotic component 110, and the data source 112 may be omitted based on the configuration and/or functions of the computing device 102. In some implementations, additional devices (not shown) may be included within the system 100. The computing devices 102, 104, the XR device 106, the XR device 108, the robotic component 110, the data source 112, and/or the network 115 may include the same or similar components as the computing system 400, as shown in FIG. 4.

As shown, the computing device 102 includes an XR workflow platform 114, an administration interface component 116, a workflow configuration component 118, an XR service component 120, a machine learning component 122, a feedback component 124, and a database 126. The computing device 102 may include additional or fewer components than what is illustrated in FIG. 1A. The functions of one or more of the XR workflow platform 114, the administration interface component 116, the workflow configuration component 118, the XR service component 120, the machine learning component 122, the feedback component 124, and the database 126 may be performed by and/or distributed among multiple other devices of the system 100. In some implementations, two or more of the XR workflow platform 114, the administration interface component 116, the workflow configuration component 118, the XR service component 120, the machine learning component 122, the feedback component 124, and the database 126 may be integrated into a single component.

Each computing device 102, 104 (collectively referred to as the “computing device(s) 102, 104”) represents a computing device (e.g., desktop computer, laptop, server, etc.) or a collection of connected computing devices that are owned and/or operated by a common entity (e.g., company, organization, etc.). Although FIG. 1A shows two computing devices 102, 104, the system 100 may include an arbitrary number of computing devices 102, 104. The computing device(s) 102, 104 may be connected to the XR device(s) 106, 108 (collectively referred to as the “XR device(s) 106, 108”), the robotic component(s) 110 (collectively referred to as the “robotic component(s) 110”), and/or the data source(s) 112 (collectively referred to as the “data source(s) 112”) via the network 115. In some implementations, the network 115 may include a wide area network (WAN), a wireless WAN (WWAN), a virtual private network (VPN), a local area network (LAN), a WiFi network, a WiMax network, a cellular network (e.g., 3G, 4G, 5G, LTE), a telephone network, a landline network, a public switched telephone network (PSTN), or any other type of network capable of enabling communication between the computing device(s) 102, 104, the XR device(s) 106, 108, the robotic component(s) 110, and/or the data source(s) 112. The computing device(s) 102, 104, the XR device(s) 106, 108, the robotic component(s) 110, and the data source(s) 112 may communicatively connect to the network 115 in accordance with various protocols, such as Hypertext Transfer Protocol (HTTP), Transmission Control Protocol (TCP), Internet Protocol (IP), User Datagram Protocol (UDP), Bluetooth®, Bluetooth® Low Energy (BLE), TLS, SSL, or a combination thereof, for example.

The administration interface component 116 provides an interface for managing the workflow configuration. In some implementations, the administration interface component 116 may provide a graphical user interface (GUI) accessible through a web browser. In some implementations, the administration interface component 116 may include a command-line interface or an application programming interface (API). The administration interface component 116 may allow administrators to perform any number of different functions associated with a workflow such as, for example, defining workflow steps, setting security parameters, configuring data sources, or managing user permissions, among other examples.

The administration interface component 116 may provide a set of tools for configuring and managing workflows within the XR environment. In some implementations, the administration interface component 116 may offer drag-and-drop functionality, allowing administrators to visually construct workflow diagrams by arranging and connecting workflow steps, data sources, and user roles. The administration interface component 116 may also include templates for common workflow patterns, which administrators can customize to suit specific needs. Additionally, the administration interface component 116 may provide real-time previews of the XR environment, allowing administrators to visualize how changes to the workflow configuration will impact the user experience.

In some aspects, the administration interface component 116 may incorporate security features to ensure proper access control and data protection. The administration interface component 116 may allow administrators to define granular permissions for different user roles, controlling access to specific workflow steps, data sources, or XR environment features. The administration interface component 116 may also provide tools for integrating with existing identity management systems, enabling single sign-on capabilities or streamlining user authentication processes. Furthermore, the administration interface component 116 may include audit logging functionality, tracking all configuration changes or user actions to support compliance requirements or facilitate troubleshooting. The administration interface component 116 may offer simulation capabilities, allowing administrators to test workflow configurations or security settings in a sandbox environment before deploying them to the live XR system.

The workflow configuration component 118 may be configured to generate workflow configurations. The workflow configuration component 118 may generate a workflow configuration based on workflow parameters determined from workflow data. In some implementations, the workflow configuration component 118 may use machine learning algorithms to optimize workflow configurations based on historical performance data.

In some implementations, the workflow configuration component 118 may analyze the workflow data obtained from various sources to determine workflow parameters associated with the workflow. The workflow parameters may include values corresponding to workflow steps, workflow dependencies, security parameters, data processing parameters, data transformation parameters, data transfer parameters, data schema parameters, or a combination thereof, among other examples. The workflow configuration component 118 may generate a workflow configuration based on these workflow parameters. The workflow configuration component 118 may generate the workflow configuration by defining, for example, the workflow steps, data sources, user roles, security policies, data processing parameters, data transfer parameters, and data schema parameters that will be used to execute the workflow in the XR environment. In some implementations, the workflow configuration component 118 may also generate visualizations of the workflow steps, data sources, and user roles for administrative review.

In some implementations, a workflow step may represent a discrete aspect of the workflow process that is to be performed by one or more users. Workflow parameters, derived from the workflow data and usable by the workflow configuration component 118 to generate the workflow configuration, may include, for example, the name of the workflow step, the data type to be processed, the parameters for processing the data, the user roles associated with the workflow step, and the data sources from which data is retrieved for processing, among other examples. Workflow dependencies may represent dependencies between workflow steps and/or data. Workflow parameters may include, for example, data dependency information and associated parameters, workflow step dependency information and associated parameters, or security parameter information and associated parameters, among other examples. Security parameters may include parameters that control access to workflow steps, data, or other aspects of the workflow. Security parameters may include, for example, user roles, user permission information, data access credentials, or data sensitivity information, among other examples.

Data processing parameters may control the processing of data. Data processing parameters may include, for example, data schema information, data transformation parameters, data compression parameters, or data filtering parameters, among other examples. Data schema parameters may indicate, for example, data dimensions, data elements, data categories, or data tags associated with a workflow step. Data transfer parameters may include parameters that control the transmission of data between components of the system such as, for example, the computing devices 102, 104, the XR device(s) 106, 108, the robotic component(s) 110, and the data source(s) 112. Data transfer parameters may include, for example, transmission source identifiers, transmission destination identifiers, data processing parameters, data transformation parameters, format settings, or data encryption parameters, among other examples. Data transformation parameters may include parameters for transforming data and may include, for example, data aggregation parameters, data filtering parameters, or data processing parameters to reduce the size, complexity, or sensitivity of data before being transmitted to another component, among other examples.

In generating the workflow configuration, the workflow configuration component 118 may create a data structure based on workflow parameters. For instance, the workflow configuration component 118 may generate a workflow configuration data structure that includes workflow steps, data sources, user roles, security policies, automation instructions, and a data schema associated with each step. This data structure may specify the organization, structure, and format of data associated with the workflow. This comprehensive configuration may serve as a blueprint for executing the workflow in the collaborative XR virtual environment.

The workflow configuration component 118 may incorporate algorithms to optimize workflow configurations. In some cases, the workflow configuration component 118 may utilize machine learning techniques to analyze historical performance data and identify patterns that can improve workflow efficiency. This may involve adjusting the sequence of workflow steps, reallocating resources, or modifying data processing rules to enhance overall productivity. For example, the workflow configuration component 118 may identify bottlenecks that occur at specific points in the workflow and implement optimization strategies to eliminate them. As another example, the workflow configuration component 118 may identify relationships between certain workflow steps and determine how best to synchronize and coordinate their execution.

To incorporate machine learning algorithms, the workflow configuration component 118, the workflow configuration component 118 may leverage the machine learning component 122. The machine learning component 122 may include one or more machine learning models. Machine learning represents a field of study that gives computers the ability to learn without being explicitly programmed. Machine learning explores the study and construction of machine learning models that may learn from existing data and make predictions about new data. Such machine learning models build a model using a set of training data to make data-driven predictions or decisions expressed as outputs or classifications. In some implementations, outputs produced by the machine learning models include workflow steps, data sources, user roles, security parameters, data processing parameters, data transfer parameters, data schema parameters, or a combination thereof, among other examples.

In some implementations, the machine learning component 122 may include any number of different types of machine learning models. For example, the machine learning models may be based on, for example, linear regression, logistic regression, decision trees, support vector machines (SVM), Naïve-Bayes, k-nearest neighbors (Knn), K-Means, random forest, graphical models, neural networks (e.g., recurrent neural networks (RNN), convolutional neural networks (CNN)), and/or a combination thereof, among other examples.

In some implementations, the machine learning component 122 can include an artificial neural network, such as a deep neural network. Neural networks are a family of statistical learning models inspired by the biological neural networks of animals, and in particular, the brain. Neural networks can be used to model complex relationships between inputs and outputs or to find patterns in data, where the dependency between the inputs and the outputs cannot be easily achieved through other types of mathematical models.

In some implementations, the machine learning component 122 may be configured to train, retrain, validate, refine, and/or deploy one or more machine learning models. For example, the machine learning component 122 may configure and deploy a reinforcement learning model that optimizes the workflow configuration based on, for example, the performance of workflow steps, data sources, user roles, security parameters, data processing parameters, data transfer parameters, and/or data schema parameters, among other examples. In some implementations, the machine learning component 122 may use historical data to refine the machine learning models, which may improve the accuracy of the models over time. The machine learning component 122 may periodically retrain the machine learning models using new data to keep the models current and accurate. The machine learning training may include any number of different techniques. For example, the machine learning techniques may include supervised learning, semi-supervised learning, unsupervised learning, or reinforcement learning, among other examples, and the machine learning models may include linear regression, logistic regression, support vector machines (SVM), Naïve-Bayes, k-means, random forest, graphical models, or neural networks (e.g., recurrent neural networks (RNN), convolutional neural networks (CNN)), among other examples.

In some implementations, the machine learning component 122 may employ transfer learning techniques. Transfer learning refers to a process of transferring knowledge acquired during the training of a model during a first training process or a first instance to a second training process or a second instance involving a different domain. For example, a model developed to estimate a first target variable in a first manner (e.g., using a first machine learning technique) using first training data (e.g., past performance data) may be leveraged with a second type of data (e.g., a dataset that may be different that the training data or the past performance data) to train a model to predict a second target variable (e.g., for the second instance) using the second training data in a second manner (e.g., a second machine learning technique).

In some implementations, the workflow configuration component 118 may support the division of complex workflows into sub-workflows. This feature may allow for more efficient management of large-scale processes by creating modular components that can be executed independently or in parallel. The workflow configuration component 118 may generate separate collaborative XR virtual spaces for each sub-workflow, facilitating focused work on specific tasks while maintaining the overall workflow coherence. In some aspects, the workflow configuration component 118 may incorporate perplexity analysis techniques to optimize the division of workflows into sub-workflows. This analysis may involve calculating the inverse probability of successful completion for potential sub-workflows, allowing the system to determine the most efficient workflow structure. By balancing complexity and granularity, the component may create workflow configurations that maximize productivity while minimizing the risk of errors or bottlenecks.

The workflow configuration component 118 may manage the assignment of participants to specific workflow steps based on their roles or access permissions. This functionality may enhance security and efficiency by ensuring that only authorized personnel can access and modify certain parts of the workflow. The workflow configuration component 118 may interface with identity management systems, organizational databases, or user profiles, to retrieve up-to-date user role information and apply it to the workflow configuration.

The workflow configuration component 118 may manage the integration of various data sources into a workflow. The workflow configuration component 118 may establish connections with internal databases, IoT devices, sensors, and external data sources, defining how data (e.g., historical data or real-time data) is to be incorporated into the workflow execution. This may involve specifying data transformation rules, setting up data validation checks, or configuring data transfer parameters to ensure smooth information flow throughout the workflow.

In some implementations, the workflow configuration component 118 may support the configuration of multimodal communication connections between XR devices. The workflow configuration component 118 may define parameters for video, audio, text, or telemetry data exchanges within the collaborative XR virtual environment. This may enable rich, context-aware communication between workflow participants, enhancing collaboration and decision-making processes throughout the workflow execution.

The XR service component 120 manages the XR environment and communications between components. This component may be responsible for generating the collaborative XR virtual environment based on the workflow configuration. In some implementations, the XR service component 120 may support various types of XR technologies, including virtual reality (VR), augmented reality (AR), and mixed reality (MR).

The XR service component 120 may act as a central hub for coordinating and managing the various aspects of the collaborative XR virtual environment. In some implementations, the XR service component 120 may handle the real-time rendering and synchronization of virtual objects, avatars, or virtual spaces across multiple XR devices. This may involve managing complex spatial relationships, physics simulations, or object interactions within the virtual space. The XR service component 120 may also be responsible for adapting the virtual environment to different XR hardware capabilities, ensuring a consistent experience across various devices such as high-end VR headsets, mobile AR devices, or mixed reality glasses.

In some cases, the XR service component 120 may incorporate features to enhance the collaborative experience within the virtual environment. For example, the XR service component 120 may implement spatial audio systems that accurately represent the position and distance of sound sources in the virtual space, improving communication and immersion for participants. The XR service component 120 may manage haptic feedback systems, allowing users to experience tactile sensations that correspond to their interactions within the virtual environment. In some implementations, the XR service component 120 may support gesture recognition and natural language processing, enabling intuitive and efficient interaction methods for users as they navigate and manipulate the virtual workflow environment.

The feedback component 124 collects and processes system feedback. For example, the feedback component 124 may be configured to monitor a workflow execution or a collaborative XR virtual environment. The feedback component 124 may gather data from various sources, including user interactions, sensor data, or system performance metrics. In some implementations, the feedback component 124 may provide real-time analytics to help administrators monitor and improve workflow processes.

The feedback component 124 may play a role in the continuous improvement and optimization of the XR workflow platform. In some implementations, the feedback component 124 may collect data from various sources within the collaborative XR virtual environment, including user interactions, device telemetry, and system performance metrics. This comprehensive data collection may enable a holistic view of the workflow execution and user experience.

For example, the feedback component 124 may track user movements and interactions within the virtual environment, such as the time spent on specific tasks, the frequency of tool usage, or the patterns of communication between team members. This data may be used to identify areas where users may be experiencing difficulties or where the workflow could be streamlined for greater efficiency.

In some cases, the feedback component 124 may integrate with the XR devices to gather physiological data from users, such as eye movement patterns, heart rate variability, or galvanic skin response. This biometric feedback may provide insights into user stress levels, cognitive load, or engagement during different phases of the workflow. For instance, consistently elevated stress levels during a particular workflow step may indicate a need for additional training or interface improvements.

The feedback component 124 may also collect system performance data, including rendering frame rates, network latency, or computational resource utilization. This technical feedback may be valuable for optimizing the XR environment's performance across different hardware configurations and network conditions. For example, if the feedback component 124 detects consistent frame rate drops during complex visualization tasks, it may trigger adaptive rendering techniques or suggest workflow modifications to maintain a smooth user experience.

In some implementations, the feedback component 124 may employ natural language processing techniques to analyze text-based communications or transcribe and analyze voice communications within the XR environment. This analysis may reveal common issues, frequently asked questions, or emerging best practices that could be incorporated into workflow improvements or training materials.

The data collected by the feedback component 124 may be used in retraining and refining the machine learning models used by the XR workflow platform. For instance, the feedback component 124 may aggregate user interaction data to create labeled datasets for supervised learning tasks. These datasets may be used by the machine learning component 122 to retrain models that predict user behavior, optimize task allocation, or personalize the XR interface based on individual user preferences and performance patterns, among other examples.

In some aspects, the feedback component 124 may implement anomaly detection algorithms to identify unusual patterns or deviations from expected behavior in the workflow execution. These anomalies may be flagged for further investigation and may serve as valuable input for reinforcement learning models that continuously adapt and optimize the workflow configuration.

The feedback component 124 may facilitate A/B testing of different workflow configurations or XR interface designs. By systematically varying certain aspects of the virtual environment and analyzing the resulting performance and user feedback data, the system may iteratively improve the workflow design. This experimental data may be used to train machine learning models that can predict the effectiveness of new workflow configurations before they are fully implemented.

In some implementations, the feedback component 124 may generate periodic reports or real-time dashboards that visualize key performance indicators (KPIs) and trends derived from the collected feedback data. These analytics may assist administrators in making data-driven decisions about workflow optimizations, resource allocations, or training initiatives. For example, a dashboard might highlight correlations between certain workflow configurations and improved productivity, guiding future development efforts.

The feedback component 124 may also incorporate user-initiated feedback mechanisms, such as in-environment surveys, voice-activated feedback collection, or gesture-based rating systems. This direct user feedback may provide qualitative insights that complement the quantitative data collected through automated means. The combination of explicit user feedback and implicit behavioral data may enable a more nuanced understanding of the user experience and workflow effectiveness.

The database 126 may store workflow parameters, workflow configurations, user data, historical performance data, or other system information used for operation of the XR workflow platform 114. In some implementations, the database 126 may be a relational database, a NoSQL database, or a distributed database system, among other examples. The database 126 may refer to one or more databases, data structures, data stores, or the like.

The system 100 connects through the network 115 to multiple extended reality devices including XR device 106 and XR device 108. These XR devices may be head-mounted displays (HMDs), smart glasses, smartphones with AR capabilities, or any other suitable XR-capable devices. In some implementations, the XR devices may include haptic feedback systems to provide tactile sensations to users in the XR environment.

The XR device 106 includes an XR client 128 for interfacing with the XR workflow platform 114. The XR client 128 may be a software application that renders the XR environment, handles user input, and communicates with the XR workflow platform 114. In some implementations, the XR client 128 may support features such as voice commands, gesture recognition, or eye-tracking for user interaction. The XR client 128 may be, for example, a client application configured to communicate with the XR service component 120, which may be configured as a server. In some implementations, although not illustrated, the XR device 108 also may include an XR client.

The robotic component 110 may be a robotic arm, an autonomous vehicle, a drone, or any other type of robotic system that can be controlled remotely. In some implementations, the XR workflow platform 114 may transmit executable instructions to the robotic component 110 to perform physical tasks as part of the workflow.

The robotic component 110 may be designed to integrate seamlessly with the XR workflow platform 114, enabling remote operation and monitoring within the collaborative XR virtual environment. In manufacturing scenarios, the robotic component 110 may take the form of a multi-axis robotic arm equipped with various end effectors for tasks such as welding, assembly, or material handling. For instance, in an automotive manufacturing workflow, users in the XR environment may guide the robotic arm to perform precise spot welding on vehicle chassis components, with real-time feedback on weld quality and positioning displayed in the virtual space. In some implementations, the robotic arm may be automated, controlled by instructions generated by the workflow configuration component 118. In some implementations, the robotic component 110 may include mobile platforms that can navigate factory floors autonomously, transporting materials or finished products between workstations as directed by the workflow configuration.

In healthcare applications, the robotic component 110 may be utilized for tasks ranging from surgical assistance to patient care and laboratory automation. For example, in a surgical workflow, a robotic surgical system may be controlled automatically or by a surgeon operating within the XR environment, allowing for enhanced precision and remote procedures. The XR workflow platform 114 may facilitate the coordination between the surgical team, robotic component, and patient monitoring systems, providing real-time data visualization and decision support. In laboratory settings, the robotic component 110 may automate sample handling and analysis processes, with researchers able to monitor and adjust experiments through the XR interface. Agricultural implementations may involve robotic components such as autonomous tractors or drones for crop monitoring and precision farming. The system 100 may plan and execute farming operations, with the robotic component 110 carrying out tasks like targeted irrigation, fertilization, or harvesting based on real-time sensor data and workflow instructions.

The data source 112 may be an internal database, an Internet of Things (IoT) device, a sensor, or an external data source. In some implementations, multiple data sources may be connected to provide diverse types of data for the workflow. The XR workflow platform 114 may establish connections with these data sources to incorporate real-time data into the XR environment.

The data source 112 may encompass a wide range of devices and systems that provide information to the XR workflow platform 114. In manufacturing environments, the data source 112 may include sensors embedded in production machinery, quality control systems, or inventory management databases. For example, in an automotive assembly line, the data source 112 may include temperature sensors in welding equipment, torque sensors on assembly robots, or RFID readers tracking component inventory. These data sources may feed real-time information into the XR environment, enabling the XR workflow platform 114 to monitor production efficiency, identify potential bottlenecks, and make data-driven decisions to optimize the manufacturing process.

In healthcare settings, the data source 112 may integrate with various medical devices and hospital information systems. For instance, in an operating room scenario, the data source 112 may include vital sign monitors, anesthesia delivery systems, or imaging equipment such as MRI or CT scanners. The XR workflow platform 114 may aggregate this data to provide surgeons and medical staff with a comprehensive view of the patient's condition within the virtual environment. In some implementations, the data source 112 may also connect to electronic health record (EHR) systems, allowing healthcare professionals to access patient histories, medication information, or treatment plans seamlessly within the XR interface. This integration may enhance decision-making and improve patient care coordination across different departments or healthcare facilities.

In agricultural applications, the data source 112 may incorporate a network of IoT devices deployed across farmlands. These may include soil moisture sensors, weather stations, or drone-mounted multispectral cameras for crop health assessment. The XR workflow platform 114 may process this data to create detailed visualizations of crop conditions, allowing farmers to identify areas requiring irrigation, pest control, or fertilization. In some cases, the data source 112 may include market price feeds or supply chain management systems, enabling farmers to make informed decisions about harvesting and distribution within the XR environment. The integration of these diverse data sources may support precision agriculture practices, potentially increasing crop yields while optimizing resource usage.

Referring now to FIG. 1B, a block diagram of another example 130 of the system 100 for implementing the XR workflow platform 114 is shown. As shown, the XR workflow platform 114 may include a preprocessing component 132 that processes input data 138 generated from user input 134 or machine input 136. The preprocessing component 132 may perform tasks such as data cleaning, normalization, and feature extraction to prepare the input data for use in the workflow.

The user input 134 may include a wide range of interactions within the XR environment, tailored to specific industry applications. In manufacturing scenarios, user input may include gesture-based commands for manipulating virtual 3D models of products or assembly lines. For instance, a design engineer may use hand movements to resize, rotate, or modify components of a virtual prototype, while quality control personnel may input inspection results through voice commands or virtual touchscreens. In healthcare applications, user input may involve surgeons using precise hand tracking to practice complex procedures in a virtual operating room, or nurses inputting patient data through gaze-based selection in an augmented reality interface overlaid on their field of view.

Machine input 136 may derive from various automated systems or sensors integrated into the workflow. In agricultural settings, machine input may include data streams from soil moisture sensors, weather stations, or drone-mounted cameras providing real-time crop health information. This data may be automatically preprocessed and fed into the XR workflow platform 114, allowing farmers to visualize and interact with dynamic representations of their fields within the virtual environment. In industrial manufacturing, machine input may encompass real-time production metrics from assembly line robots, quality control data from automated inspection systems, or inventory levels from RFID-enabled storage facilities. The XR workflow platform 114 may synthesize this machine input to create live, interactive dashboards within the virtual space, enabling managers to monitor and optimize production processes in real-time.

The administration interface component 116 manages the input data 138, providing a user-friendly interface for administrators to configure and monitor the system. In some implementations, the administration interface component 116 may include dashboards for visualizing workflow performance metrics and tools for managing user roles and permissions.

The workflow configuration component 118 uses the processed workflow data 140 to generate a workflow configuration 142. This configuration may include specifications for workflow steps, data processing instructions, security schemes, and automation instructions. In some implementations, the workflow configuration component 118 may use AI techniques to suggest optimal workflow configurations based on historical data and current system parameters.

The XR service component 120 receives the workflow configuration 142 and generates, based on the workflow configuration 142, a collaborative XR virtual environment. The XR service component 120 manages communications with XR clients 128A and 128B, which provide user interfaces for workflow participants. In some implementations, the XR service component 120 may support features such as real-time collaboration, spatial audio, or shared virtual whiteboards to enhance user interaction in the XR environment.

The XR service component 120 also interfaces with a robotic component 110 for automated tasks, a sensor 112A for data collection, and an external data source 112B for additional information input. These components allow the XR workflow platform 114 to integrate physical world data and actions into the virtual workflow environment. In some implementations, the system may support a wide range of sensors and IoT devices to capture diverse types of data relevant to the workflow.

Referring to FIG. 1C, a block diagram of an example 144 showing the internal components of the XR service component 120 is illustrated. The XR service component 120 contains several components that work together to facilitate extended reality workflow operations. Each of the components may be implemented as hardware and/or software.

The workflow manager 146 manages workflow operations and coordination. The workflow manager 146 may be responsible for executing workflow steps, managing dependencies between steps, and ensuring the overall flow of the workflow proceeds as configured. In some implementations, the workflow manager 146 may support features such as parallel processing of workflow steps and dynamic reconfiguration of workflows based on real-time data.

The data processing manager 148 processes workflow-related data. The data processing manager 148 may handle tasks such as data transformation, aggregation, or analysis required by different workflow steps. In some implementations, the data processing manager 148 may leverage distributed computing techniques to process large volumes of data efficiently.

The data transfer manager 150 manages the movement of data between different parts of the system. It may handle tasks such as data synchronization between XR devices, data streaming from sensors, or secure data transfer to and from external sources. In some implementations, the data transfer manager 150 may employ advanced compression and encryption techniques to optimize data transfer in bandwidth-constrained environments.

The security manager 152 manages access control and security protocols. The security manager 152 may be responsible for user authentication, data encryption, or enforcing security policies across the XR environment. In some implementations, the security manager 152 may support features such as multi-factor authentication, role-based access control, and real-time threat detection to ensure the integrity and confidentiality of workflow data.

The communication manager 154 facilitates interactions between system components and users. The communication manager 154 may handle tasks such as establishing multimodal communication connections between XR devices, managing real-time audio and video streams, or coordinating data exchange between different parts of the system. In some implementations, the communication manager 154 may support features such as automatic language translation to facilitate collaboration between users speaking different languages.

The monitoring component 156 tracks and oversees system operations and workflow progress. The monitoring component 156 may collect performance metrics, generate alerts for anomalies, and provide real-time visibility into the status of ongoing workflows. In some implementations, the monitoring component 156 may use AI-driven predictive analytics to anticipate potential issues and suggest proactive measures to maintain optimal system performance.

Together, these components of the XR service component 120 enable the creation and management of sophisticated, adaptive workflows in an extended reality environment. The modular architecture allows for flexibility in implementing various workflow configurations and supports the integration of advanced features to enhance collaboration and productivity in XR-based workflows.

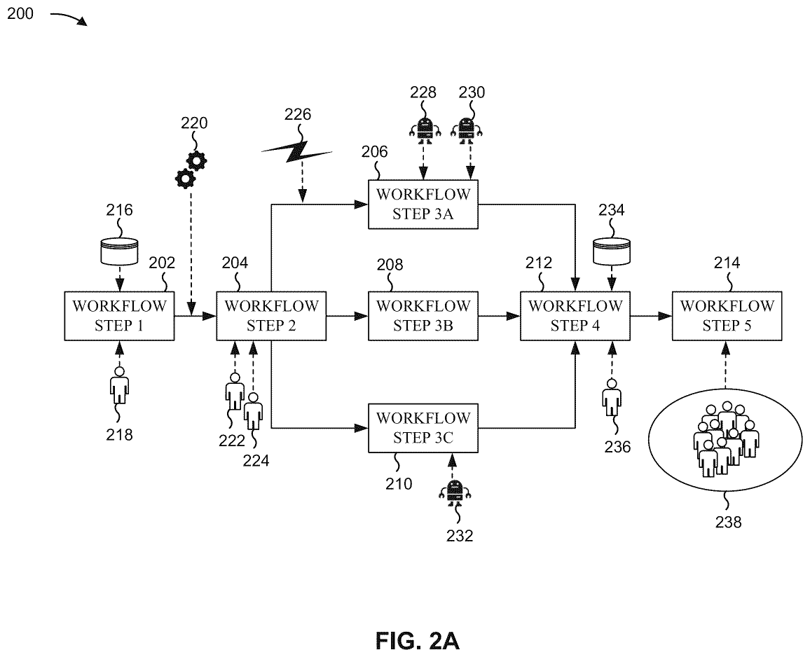

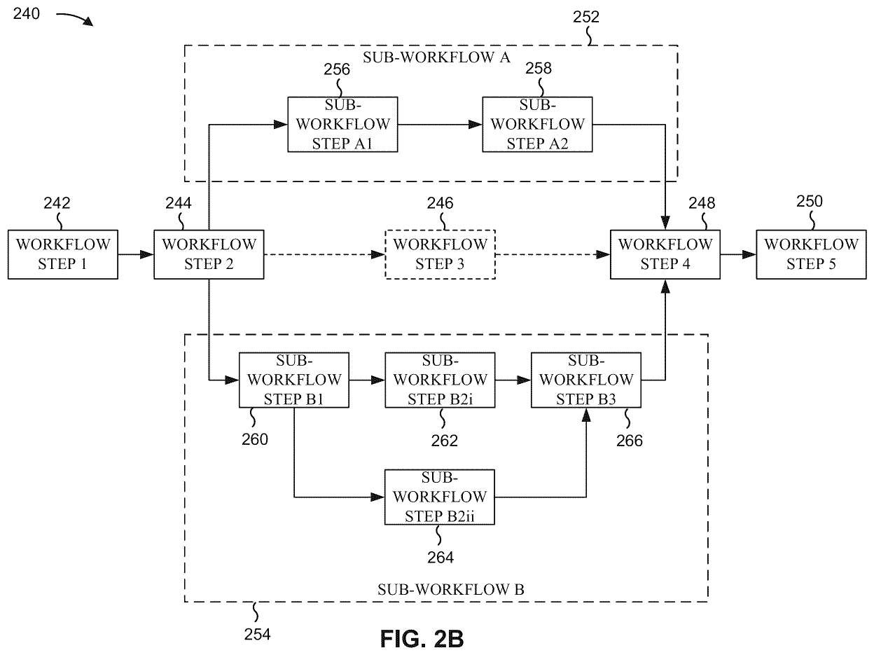

FIGS. 2A-2B are flow diagrams showing example workflows, in accordance with various implementations of the present disclosure.

Referring to FIG. 2A, a workflow 200 is illustrated including multiple interconnected workflow steps. The XR workflow platform 114 may create the workflow 200 through a multi-step process that incorporates various inputs and parameters. The workflow configuration component 118 may analyze input data 138 from both user input 134 and machine input 136 to determine the overall structure and requirements of the workflow. This analysis may involve identifying key workflow steps, such as workflow step 1 202 through workflow step 5 214, and determining their sequential and parallel relationships.

In generating the workflow configuration 142, the workflow configuration component 118 may incorporate data sources, user roles, and robotic components into specific workflow steps. For example, data 216 and user 218 inputs may be associated with workflow step 1 202, while robotic components 228 and 230 may be linked to workflow step 3A 206. The workflow configuration component 118 may also define data transformation parameters 220 and data transfer parameters 226, specifying how information should be processed and moved between different workflow steps. These parameters may facilitate smooth data flow and maintaining data integrity throughout the workflow execution.

The XR workflow platform 114 may utilize the machine learning component 122 to optimize the workflow configuration based on historical performance data and current system parameters. This may involve adjusting the sequence of workflow steps, reallocating resources, or modifying data processing rules to enhance overall productivity. For instance, the platform may analyze the efficiency of parallel processing in workflow steps 3A 206, 3B 208, and 3C 210, and dynamically adjust the distribution of tasks among these steps to minimize bottlenecks. Additionally, the XR service component 120 may generate a collaborative XR virtual environment based on the workflow configuration, enabling users such as user group 238 to interact with the workflow in an immersive, intuitive manner.

The workflow 200 begins with workflow step 1 202, which receives input from data 216 and user 218. In some implementations, workflow step 1 202 may represent an initial data gathering or preprocessing stage. For example, in a manufacturing workflow, workflow step 1 202 could involve collecting raw material specifications or customer order details. Alternatively, in a healthcare workflow, it might involve gathering patient information or initial diagnostic data.

Data transformation parameters 220 are applied between workflow steps 1 and 2. These parameters may define how data is processed or modified as it moves between workflow steps. In some implementations, data transformation parameters 220 could include data normalization rules, format conversion specifications, or data aggregation instructions. For instance, in a financial workflow, these parameters might define how raw transaction data is converted into standardized financial reports.

Workflow step 2 204 receives input from users 222 and 224. This step may represent a stage where multiple users collaborate or provide input. In some implementations, workflow step 2 204 could be a design review in an engineering workflow, where different specialists contribute their expertise. Alternatively, in a customer service workflow, it might represent a stage where multiple representatives handle different aspects of a customer inquiry.

The workflow then branches into three parallel paths through workflow step 3A 206, workflow step 3B 208, and workflow step 3C 210. This parallel structure allows for concurrent processing of different aspects of the workflow. In some implementations, these parallel steps could represent different production lines in a manufacturing process, or parallel data processing tasks in a data analytics workflow.

Data transfer parameters 226 facilitate data flow into workflow step 3A 206. These parameters may define how data is moved or shared between different parts of the workflow. In some implementations, data transfer parameters 226 could specify data encryption methods for secure transfer, data compression techniques for efficient transfer, or data synchronization protocols for maintaining consistency across parallel processes.

Robotic components 228 and 230 provide input to workflow step 3A 206, while robotic component 232 interfaces with workflow step 3C 210. These robotic components may represent automated systems or machines involved in the workflow. In some implementations, in a manufacturing workflow, these could be robotic arms performing assembly tasks. Alternatively, in a logistics workflow, they might represent automated guided vehicles moving materials between workflow stages.

The parallel workflow paths converge at workflow step 4 212, which also receives input from user 236 and connects to data 234. This convergence point may represent a stage where parallel processes are synchronized or their outputs are combined. In some implementations, in a software development workflow, this could be a code integration step where parallel development efforts are merged. Alternatively, in a multi-channel marketing workflow, it might represent the point where results from different marketing channels are aggregated and analyzed.

The workflow concludes with workflow step 5 214, which receives input from user group 238. This final step may represent a review, approval, or output generation stage. In some implementations, in a content creation workflow, this could be a final editorial review by a group of editors. Alternatively, in a financial audit workflow, it might represent a final sign-off by a group of auditors.

Referring now to FIG. 2B, a workflow 240 is illustrated that includes main workflow steps and sub-workflows. The XR workflow platform 114 may create the workflow 240 through a multi-step process that incorporates various inputs and parameters.

The workflow 240 begins with workflow step 1 242, which connects to workflow step 2 244. From workflow step 2 244, the process branches into three parallel paths. The first path proceeds to workflow step 3 246. In some implementations, the XR workflow platform may analyze workflow step 3 246 and determine that it would be more efficient to divide this step into two sub-workflows. This determination may be based on determining a perplexity associated with the step, as described herein. The determination may be based on factors such as the complexity of the step, the resources required, or the potential for parallel processing. For example, in a manufacturing workflow, step 3 246 might involve assembling a complex component. The XR workflow platform may recognize that this assembly process could be optimized by dividing it into sub-workflows for preparing individual parts and final assembly.

The second path enters sub-workflow A 252, which contains sub-workflow step A1 256 followed by sub-workflow step A2 258. Sub-workflow A 252 may represent a series of related tasks that can be executed independently of the main workflow. In some implementations, sub-workflow A 252 might be a quality control process that runs parallel to the main production line. For instance, in a pharmaceutical manufacturing workflow, sub-workflow A 252 could involve testing samples from each batch produced in the main workflow. In some implementations, in a software development workflow, sub-workflow A 252 might represent a continuous integration and testing pipeline that runs alongside the main development process.

Sub-workflow step A1 256 may be the first step in sub-workflow A 252. In some implementations, this step might involve initial data gathering or preparation tasks. For example, in a financial auditing workflow, sub-workflow step A1 256 could involve collecting relevant financial documents and organizing them for review. In some implementations, such as an automated customer service workflow, sub-workflow step A1 256 might involve analyzing the customer's initial query and categorizing it for further processing.

Sub-workflow step A2 258 follows sub-workflow step A1 256 in sub-workflow A 252. This step may build upon the results of sub-workflow step A1 256. In some implementations, sub-workflow step A2 258 might involve more complex processing or decision-making based on the information gathered in the previous step. For instance, in a medical diagnosis workflow, if sub-workflow step A1 256 involved gathering patient symptoms, sub-workflow step A2 258 might involve analyzing these symptoms and generating potential diagnoses. In some implementations, in a supply chain management workflow, sub-workflow step A2 258 might involve optimizing inventory levels based on the data collected in sub-workflow step A1 256.

The third path enters sub-workflow B 254, which contains a sequence of steps beginning with sub-workflow step B1 260. Sub-workflow B 254 may represent another set of tasks that can be executed independently of the main workflow and sub-workflow A 252. In some implementations, sub-workflow B 254 might be a parallel processing path that handles a specific aspect of the overall workflow. For example, in an e-commerce order fulfillment workflow, while the main workflow handles order processing, sub-workflow B 254 might manage inventory updates and reordering processes. In some implementations, such as a content creation workflow, sub-workflow B 254 could handle media asset management and processing while the main workflow focuses on content development.

Sub-workflow step B1 260 is the initial step in sub-workflow B 254. This step may involve setting up or initializing processes specific to sub-workflow B 254. In some implementations, sub-workflow step B1 260 might involve data validation or preprocessing tasks. For instance, in a machine learning workflow, sub-workflow step B1 260 could involve data cleaning and normalization before the data is used for model training. In some implementations, in a customer onboarding workflow, sub-workflow step B1 260 might involve verifying customer information and setting up initial account parameters.

Within sub-workflow B 254, sub-workflow step B1 260 branches into two parallel paths. One path leads to sub-workflow step B2i 262, while the other path leads to sub-workflow step B2ii 264. This parallel structure within sub-workflow B 254 allows for concurrent processing of different aspects of the sub-workflow. In some implementations, these parallel steps might represent different analyses or processes that can be performed independently on the same data. For example, in a social media analytics workflow, sub-workflow step B2i 262 might focus on sentiment analysis of user comments, while sub-workflow step B2ii 264 simultaneously performs trend analysis on the same dataset.

Sub-workflow step B2i 262 represents one of the parallel paths within sub-workflow B 254. In some implementations, this step might involve a specific type of analysis or processing that is independent of sub-workflow step B2ii 264. For instance, in a financial risk assessment workflow, sub-workflow step B2i 262 could focus on analyzing market trends, while sub-workflow step B2ii 264 examines company-specific financial data. In some implementations, in a product development workflow, sub-workflow step B2i 262 might involve user interface design, while sub-workflow step B2ii 264 simultaneously handles backend development.

Sub-workflow step B2ii 264 represents the other parallel path within sub-workflow B 254. This step may complement or contrast with the processing done in sub-workflow step B2i 262. In some implementations, sub-workflow step B2ii 264 might provide a different perspective or approach to the same problem addressed in sub-workflow step B2i 262. For example, in a cybersecurity workflow, if sub-workflow step B2i 262 uses rule-based detection methods, sub-workflow step B2ii 264 might employ machine learning-based anomaly detection on the same network traffic data. In some implementations, such as a content localization workflow, sub-workflow step B2i 262 might handle text translation while sub-workflow step B2ii 264 simultaneously adapts graphical elements for different cultural contexts.

Both paths from sub-workflow steps B2i 262 and B2ii 264 converge at sub-workflow step B3 266. This convergence point may represent a stage where the results from the parallel processes are combined or reconciled. In some implementations, sub-workflow step B3 266 might involve data aggregation, decision-making based on multiple inputs, or final processing before the sub-workflow results are integrated back into the main workflow. For instance, in a multi-channel marketing workflow, if the previous steps analyzed different marketing channels separately, sub-workflow step B3 266 might combine these analyses to provide a comprehensive view of the marketing campaign's performance. In some implementations, in a drug discovery workflow, sub-workflow step B3 266 might combine the results of parallel molecular simulations to determine the most promising drug candidates for further testing.

The outputs from sub-workflow A 252 and sub-workflow B 254 converge at workflow step 4 248. This convergence point in the main workflow may represent a stage where the results from the sub-workflows are integrated or synchronized. In some implementations, workflow step 4 248 might involve data consolidation, overall process evaluation, or preparation for the final stages of the workflow. For example, in a complex manufacturing process, workflow step 4 248 might involve assembling components produced in parallel paths, conducting final quality checks, and preparing the product for shipping. In some implementations, such as a large-scale data analysis workflow, workflow step 4 248 might involve combining insights from multiple data processing streams, validating the results, and preparing a comprehensive report.

The workflow 240 concludes with workflow step 5 250. This final step may represent the completion of the overall process or the generation of the final output. In some implementations, workflow step 5 250 might involve final approvals, documentation, or the initiation of follow-up processes. For instance, in a software release workflow, workflow step 5 250 could involve final testing, documentation updates, and the actual deployment of the software to production servers. In some implementations, in a complex financial transaction workflow, workflow step 5 250 might involve final compliance checks, transaction execution, and the generation of confirmation notices to all involved parties.

The flowchart shows how the workflow 240 incorporates parallel processing through the use of sub-workflows, with sub-workflow A 252 and sub-workflow B 254 operating independently before rejoining the main workflow sequence. This structure allows for concurrent execution of different workflow components while maintaining overall process flow from start to finish. In some implementations, the XR workflow platform may dynamically adjust the execution of these sub-workflows based on real-time data and resource availability, optimizing the overall workflow performance.

The workflow structures illustrated in FIGS. 2A and 2B illustrate the system's capability to handle complex, multi-step workflows with parallel processing, sub-workflows, and intricate dependencies. The collaborative XR virtual environment generated based on these workflow configurations may enable XR-based communication exchanges between multiple XR devices. This environment may include avatars representing participants, facilitating interaction between on-site and remote users across the various workflow steps and sub-workflows.

In some implementations, the system may establish connections between various data sources and the XR workflow platform. For instance, data 216 and data 234 in FIG. 2A might represent inputs from internal databases, IoT devices, sensors, or external data sources, providing real-time information to inform the workflow processes. In some implementations, the system may establish multimodal communication connections between XR devices to facilitate collaboration across the workflow. These connections could support video, audio, text, or telemetry data exchanges, enabling rich, context-aware communication within each workflow step and sub-workflow. In some implementations, the system may transmit executable instructions to robotic components, such as robotic components 228, 230, and 232 in FIG. 2A, to automate certain workflow operations. This integration of XR-based human collaboration with robotic automation demonstrates the comprehensive and flexible nature of the workflow system disclosed herein.

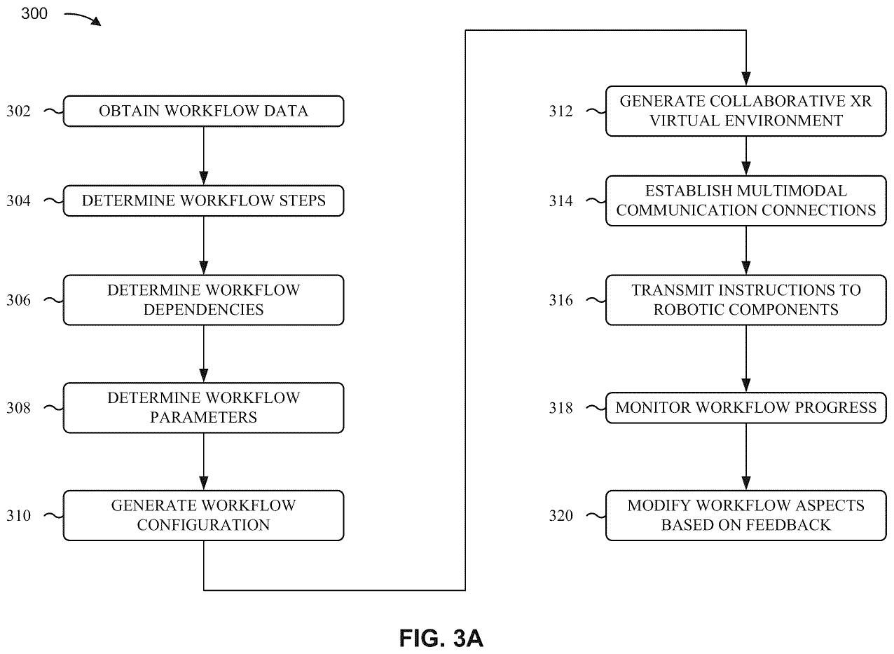

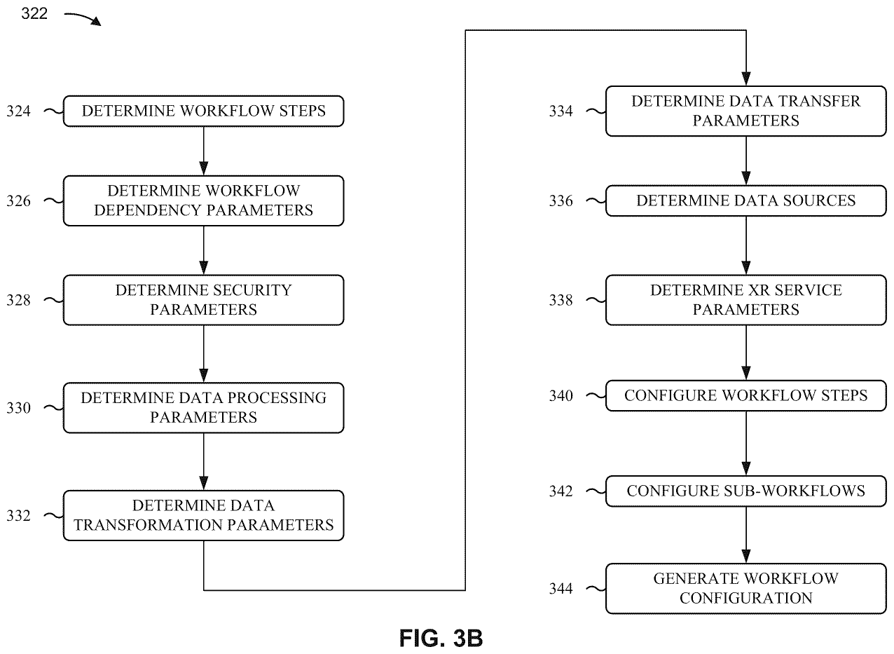

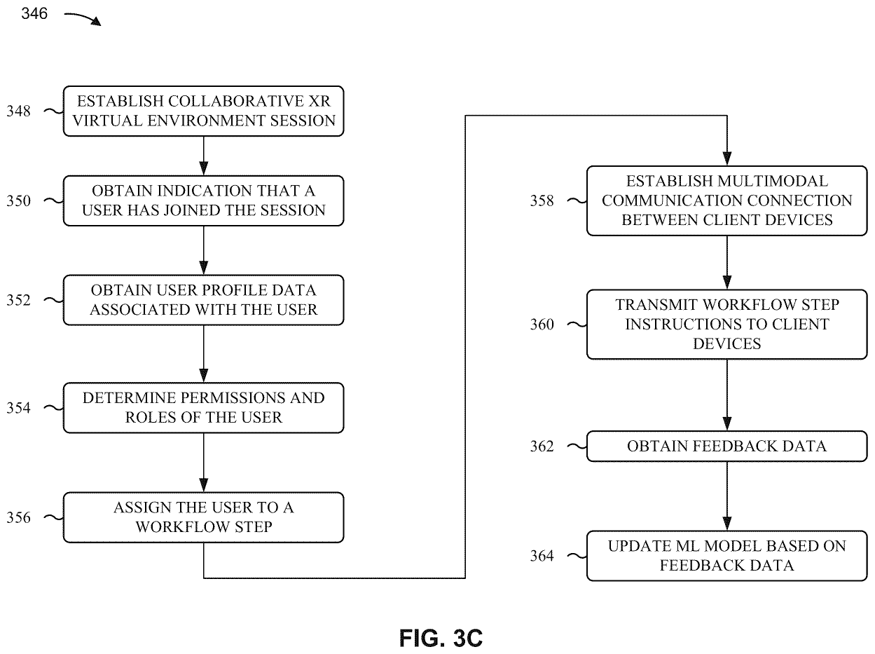

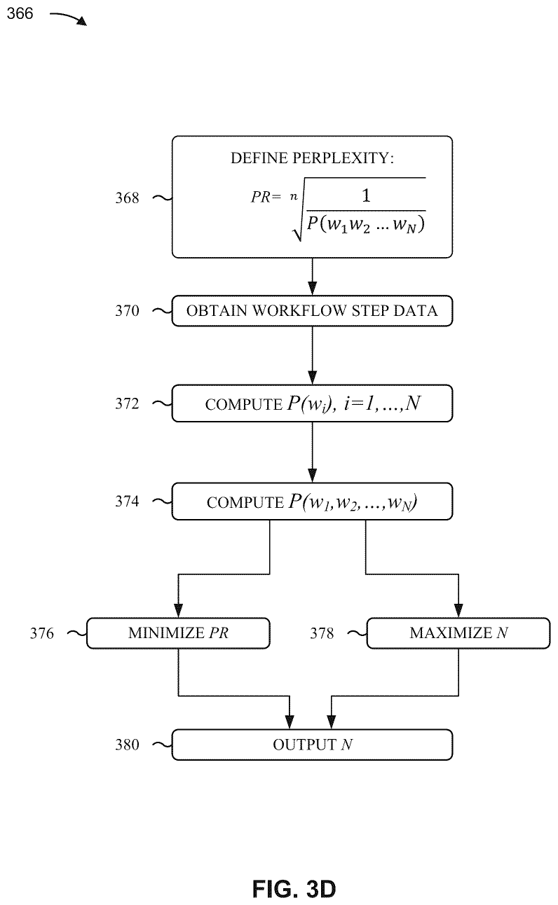

FIGS. 3A-3D are flow diagrams of example processes associated with collaborative XR virtual environments, in accordance with various implementations of the present disclosure. The processes illustrated in FIGS. 3A-3D may be performed, for example, by an XR workflow platform (e.g., the XR workflow platform 114 shown in FIGS. 1A-1C).

Referring to FIG. 3A, a process 300 for implementing an XR workflow system is illustrated. The process 300 begins at step 302, where workflow data is obtained. In some implementations, this workflow data may be received from an administrator through an administration interface component. In some implementations, the workflow data may be imported from existing workflow management systems or extracted from historical process logs. The workflow data may include information such as the sequence of steps in a workflow, the resources required for each step, and the expected outcomes.

At step 304, the workflow steps are determined from the obtained data. This step may involve analyzing the workflow data to identify distinct stages or operations within the overall process. In some implementations, machine learning algorithms may be employed to recognize patterns and automatically segment the workflow into logical steps. In some implementations, predefined templates or rule-based systems may be used to structure the workflow steps based on industry-specific best practices.

The process 300 then proceeds to step 306, where workflow dependencies are determined. This step involves identifying the relationships and constraints between different workflow steps. In some implementations, this may include temporal dependencies (e.g., step B must follow step A), resource dependencies (e.g., step C requires output from step A), or conditional dependencies (e.g., step D is only performed if certain conditions are met). The XR workflow platform may use graph analysis techniques or constraint satisfaction algorithms to model and optimize these dependencies.

At step 308, workflow parameters are determined based on the previous analysis. These parameters may include timing estimates, resource allocations, data flow specifications, or security requirements for each workflow step. In some implementations, historical data and machine learning models may be used to predict optimal parameter values. In some implementations, domain experts may provide input to fine-tune these parameters based on their experience and knowledge of the specific workflow context.

The process 300 then moves to step 310, where a workflow configuration is generated using the determined parameters. This configuration may take the form of a structured data object or file that encapsulates all the information needed to execute the workflow in an XR environment. In some implementations, the configuration may be represented using a standardized format such as BPMN (Business Process Model and Notation) or XPDL (XML Process Definition Language). In some implementations, a custom configuration format may be developed to capture XR-specific workflow attributes.

Following the workflow configuration, at step 312, a collaborative XR virtual environment is generated. This step involves creating a virtual space that represents the workflow and allows multiple users to interact within it. In some implementations, this may include generating 3D models of workflow elements, designing user interfaces for different roles, or establishing communication channels between participants. The XR environment may be built using game engines or specialized XR development platforms.

The process 300 continues at step 314, where multimodal communication connections are established. This step enables participants in the XR environment to communicate effectively using various modalities such as voice, text, gestures, or data visualizations. In some implementations, this may involve setting up voice over IP (VOIP) channels, integrating natural language processing for text-based interactions, or implementing hand tracking for gesture recognition. The XR workflow platform may also support real-time language translation to facilitate collaboration between multilingual teams.

At step 316, instructions are transmitted to robotic components. This step allows the XR workflow system to interface with physical automation systems or digital bots that may be involved in the workflow. In some implementations, these instructions may be sent using standardized protocols like OPC UA (Open Platform Communications Unified Architecture) for industrial automation. In some implementations, custom APIs may be developed to control specific robotic systems or software agents integrated into the workflow.

The process 300 then proceeds to step 318, where workflow progress is monitored. This involves tracking the status of each workflow step, collecting performance metrics, and identifying any bottlenecks or issues. In some implementations, real-time dashboards may be generated within the XR environment to visualize workflow progress. The XR workflow platform may employ predictive analytics to forecast potential delays or resource shortages based on current progress and historical data.

At step 320, workflow aspects are modified based on feedback received during the monitoring. This step allows the XR workflow platform to adapt and optimize the workflow in real-time. In some implementations, this may involve automatically adjusting resource allocations, rerouting tasks to available personnel, or modifying step sequences to improve efficiency. The XR workflow platform may use reinforcement learning techniques to continuously improve its decision-making process for workflow modifications based on observed outcomes.

Referring now to FIG. 3B, a process 322 for configuring workflow parameters and generating a workflow configuration is illustrated. The process 322 begins at step 324, where workflow steps are determined. This step may involve breaking down a complex process into discrete, manageable tasks. In some implementations, this could be done through automated analysis of process documentation or by interviewing subject matter experts. The XR workflow platform may use process mining techniques to discover workflow steps from event logs of existing systems.

The process 322 then proceeds to step 326, where workflow dependency parameters are determined. This involves identifying and quantifying the relationships between different workflow steps. In some implementations, this may include calculating paths, identifying parallel processes, or determining resource contention points. The XR workflow platform may use techniques from operations research, such as PERT (Program Evaluation and Review Technique) or CPM (Critical Path Method), to analyze and optimize these dependencies.

At step 328, security parameters are determined. This step involves defining access controls, data protection measures, and compliance requirements for the workflow. In some implementations, this may include role-based access control (RBAC) schemes, encryption protocols for data in transit and at rest, or audit logging mechanisms. The XR workflow platform may integrate with existing identity and access management (IAM) systems or implement blockchain-based solutions for enhanced security and traceability in collaborative workflows.

The process 322 continues to step 330, where data processing parameters are established. These parameters define how data is handled, transformed, and analyzed throughout the workflow. In some implementations, this may involve specifying data formats, defining transformation rules, or setting up data validation checks. The XR workflow platform may leverage ETL (Extract, Transform, Load) tools or stream processing frameworks to handle real-time data flows within the workflow.

From step 330, the process 322 flows to step 332, where data transformation parameters are determined. These parameters specify how data is converted or manipulated between workflow steps. In some implementations, this may include defining mathematical operations, statistical analyses, or machine learning model applications to be performed on the data. The XR workflow platform may use domain-specific languages (DSLs) or visual programming interfaces to allow non-technical users to define complex data transformations.

The process 322 then moves to step 334, where data transfer parameters are determined. These parameters define how information is moved between different steps or participants in the workflow. In some implementations, this may involve specifying data serialization formats, compression algorithms, or network protocols for efficient data transfer. The XR workflow platform may implement adaptive data transfer mechanisms that adjust based on network conditions or data priorities to ensure optimal performance in various operating environments.

At step 336, the process 322 determines data sources for the workflow. This involves identifying and configuring connections to various information repositories or real-time data streams required by the workflow. In some implementations, this may include setting up database connections, API integrations, or IoT device interfaces. The XR workflow platform may use data virtualization techniques to provide a unified view of diverse data sources, simplifying data access within the XR environment.

The process 322 then proceeds to step 338, where XR service parameters are determined. These parameters define how the workflow will be represented and interacted with in the extended reality environment. In some implementations, this may include specifying 3D model requirements, defining interaction paradigms, or setting up spatial audio configurations. The XR workflow platform may support multiple XR platforms (e.g., VR headsets, AR glasses, mobile devices) and adapt the XR representation based on the capabilities of each device.

At step 340, the workflow steps are configured based on the previously determined parameters. This involves combining all the defined parameters into a coherent structure that can guide the execution of each workflow step in the XR environment. In some implementations, this may include creating state machines, defining transition rules, or setting up event triggers for each step. The XR workflow platform may use visual workflow editors or domain-specific configuration languages to facilitate this process for complex workflows.

The process 322 then proceeds to step 342 to configure sub-workflows. This step allows for the modular organization of complex processes by defining nested or parallel workflow structures. In some implementations, this may involve creating reusable workflow components, defining integration points between sub-workflows, or setting up conditional execution paths. The XR workflow platform may employ hierarchical workflow models or microservices architectures to manage and execute these sub-workflows efficiently.

The process 322 concludes at step 344 with the generation of the workflow configuration. This step produces a comprehensive representation of the workflow that can be interpreted and executed by the XR workflow platform. In some implementations, this configuration may be serialized into a standardized format like JSON or XML for storage and distribution. The XR workflow platform may generate human-readable documentation or visual representations of the workflow configuration to aid in review and validation processes.

Referring to FIG. 3C, a process 346 for managing user participation in an XR workflow environment is illustrated. The process 346 begins at step 348, where a collaborative XR virtual environment session is established. This involves initializing the virtual space, loading necessary assets, and preparing the environment for user interaction. In some implementations, this may include setting up physics simulations, initializing AI agents, or configuring environmental parameters like lighting and sound. The XR workflow platform may use distributed computing techniques to ensure low-latency initialization of the XR environment across multiple user devices.

At step 350, the process obtains an indication that a user has joined the session. This step involves detecting and authenticating a new participant entering the XR environment. In some implementations, this may include verifying login credentials, performing device compatibility checks, or initializing user-specific settings. The XR workflow platform may support various authentication methods, including biometric verification or single sign-on (SSO) integration with enterprise identity systems.

The process 346 then proceeds to step 352, where user profile data associated with the user is obtained. This data may include information such as the user's role, skills, preferences, or historical performance in similar workflows. In some implementations, this profile data may be retrieved from HR systems, learning management systems, or custom user databases. The XR workflow platform may employ privacy-preserving techniques like federated learning to leverage user data for personalization while maintaining data confidentiality.

At step 354, the process determines permissions and roles of the user. This involves mapping the user's profile to specific access rights and responsibilities within the workflow. In some implementations, this may include dynamic role assignment based on current workflow needs and user availability. The XR workflow platform may use AI-driven role matching algorithms to optimize team composition and task allocation based on user skills and workflow requirements.

Following this determination, at step 356, the user is assigned to a workflow step. This involves placing the user within the appropriate part of the XR environment and providing them with the necessary tools and information to perform their tasks. In some implementations, this may include spawning user avatars, configuring personal workspaces, or initializing role-specific user interfaces. The XR workflow platform may support seamless transitions between different workflow steps, allowing users to move between tasks as needed while maintaining context.

After the user assignment, the process 346 moves to step 358, where a multimodal communication connection is established between client devices. This enables users to interact effectively within the XR environment using various communication channels. In some implementations, this may include setting up spatial audio systems, configuring shared whiteboards, or initializing collaborative 3D modeling tools. The XR workflow platform may adapt communication modalities based on user preferences, device capabilities, or current workflow context to optimize collaboration effectiveness.

At step 360, workflow step instructions are transmitted to client devices. This involves providing users with the necessary guidance to perform their assigned tasks within the XR environment. In some implementations, this may include displaying interactive 3D tutorials, providing context-sensitive help systems, or offering AI-assisted guidance for complex procedures. The XR workflow platform may personalize instruction delivery based on user learning styles, prior experience, or real-time performance metrics to maximize task comprehension and efficiency.

The process 346 then continues to step 362, where feedback data is obtained. This involves collecting information about user actions, task outcomes, or system performance within the XR workflow environment. In some implementations, this may include tracking user movements, monitoring task completion times, or gathering subjective user feedback through in-environment surveys. The XR workflow platform may employ non-intrusive data collection methods, such as eye-tracking or physiological sensors, to gather rich feedback data without disrupting user workflow.

The process 346 concludes at step 364, where a machine learning model is updated based on the feedback data. This step allows the system to continuously improve its performance and adapt to changing workflow requirements. In some implementations, this may involve retraining neural networks, updating reinforcement learning policies, or refining natural language processing models. The XR workflow platform may use techniques like transfer learning or meta-learning to efficiently adapt models across different workflows and user populations, ensuring robust performance in diverse scenarios.

Referring now to FIG. 3D, a process 366 for assessing and optimizing the complexity of a workflow by utilizing a mathematical measure referred to as “perplexity.” The process 366 begins at step 368, where perplexity (PR) is defined using a mathematical formula involving the number of workflow steps (N) and probability values. This formula provides a measure of the complexity or uncertainty in the workflow. In some implementations, the perplexity may be calculated as:

$$\sqrt[n]{\frac{1}{P ( {w}_{1} {w}_{2} … {w}_{N} )}} ,$$

where P(wᵢ) is the probability of an individual work portion being completed successfully; i=1, . . . , N; N is the number of work portions; and P(w₁ w₂ . . . w_{N}) is the probability of all work elements being completed successfully. The XR workflow platform may use various probability estimation techniques, such as Bayesian networks or Markov models, to compute these probabilities based on historical workflow data and current system state.

At step 370, workflow step data is obtained. This involves gathering detailed information about each step in the workflow, including task descriptions, resource requirements, and performance metrics. In some implementations, this data may be extracted from workflow management systems, process documentation, or real-time monitoring of ongoing workflows. The XR workflow platform may use natural language processing techniques to extract structured information from unstructured workflow descriptions, enabling automated analysis of diverse workflow types.

The process 366 continues to step 372, where individual probability values P(wᵢ) are computed for each workflow step i from 1 to N. These probabilities represent the likelihood of successfully completing each individual step. In some implementations, these probabilities may be estimated using statistical models, expert knowledge bases, or machine learning classifiers trained on historical workflow data. The XR workflow platform may incorporate real-time factors such as resource availability, user expertise, and environmental conditions to dynamically update these probability estimates.

At step 374, the joint probability P(w₁ w₂ . . . w_{N}) is computed for all workflow steps. This represents the overall probability of successfully completing the entire workflow. In some implementations, this joint probability may be calculated using chain rule decomposition, taking into account step dependencies and conditional probabilities. The XR workflow platform may use probabilistic graphical models like Bayesian networks to efficiently represent and compute these joint probabilities for complex workflows with many interdependent steps.

From step 374, the process 366 branches into two parallel paths. One path leads to step 376, where the perplexity value PR is minimized. This involves finding workflow configurations that reduce uncertainty and increase the likelihood of successful completion. In some implementations, this may include techniques such as simulated annealing, genetic algorithms, or gradient-based optimization methods to search the space of possible workflow configurations. The system may use multi-objective optimization approaches to balance perplexity minimization with other important factors like resource utilization or completion time.

The other path leads to step 378, where the number of workflow steps N is maximized. This step aims to increase the granularity and detail of the workflow representation while maintaining manageability. In some implementations, this may involve techniques for workflow decomposition, such as hierarchical task network planning or process mining algorithms that identify sub-processes within larger workflows. The system may employ adaptive workflow refinement techniques that dynamically adjust the level of granularity based on user expertise and current operational context.

Both paths converge at step 380, where the optimized value of N is output. This step produces a recommendation for the optimal number of workflow steps that balances complexity reduction (low perplexity) with process detail (high N). In some implementations, this output may include multiple recommendations for different scenarios or user roles, allowing workflow designers to make informed decisions based on specific requirements. The system may provide interactive visualizations or what-if analysis tools to help users understand the trade-offs between different workflow configurations and their impact on overall process performance.

The measure of perplexity inversely correlates with the entropy of the workflow system. A lower perplexity value signifies reduced entropy, indicating a more predictable and efficient system. This reduction in entropy is desirable in decision-making processes, particularly when determining the sequence of operations required to complete a specific work item. Accordingly, the methodology includes steps to minimize the perplexity of a workflow, thereby facilitating a streamlined and efficient operational structure.

The processes illustrated in FIGS. 3A-3D demonstrate the comprehensive approach of the disclosed XR workflow platform in analyzing, configuring, and optimizing workflows for collaborative XR environments. By incorporating advanced techniques in data analysis, machine learning, and XR technology, the system provides a flexible and adaptive solution for managing complex workflows across various industries and use cases.

In parallel, the methodology further emphasizes the maximization of work steps N, which allows for the decomposition of the workflow into discrete, manageable components. This dual objective of minimizing the probabilities P(wᵢ) while maximizing the number of work steps N introduces a multi-objective optimization challenge.

In some implementations, the methodology may employ a Mixed Integer Optimizer. This optimization approach may be configured to solve the multi-objective problem by identifying optimal values for the probability parameters P(wᵢ) and the number of work steps N that achieve a balance between minimizing perplexity and maximizing workflow decomposition. The resultant optimization may enhance the operational efficiency of the workflow system while maintaining its modular structure.

This methodology may be particularly useful in applications requiring the evaluation and improvement of complex workflows, such as those encountered in industrial operations, software development processes, or logistical planning. By systematically addressing the interplay between perplexity and workflow decomposition, the disclosed techniques provide a robust framework for enhancing operational predictability and efficiency.

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as XR virtual environment platform code, shown in block 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. In some implementations, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

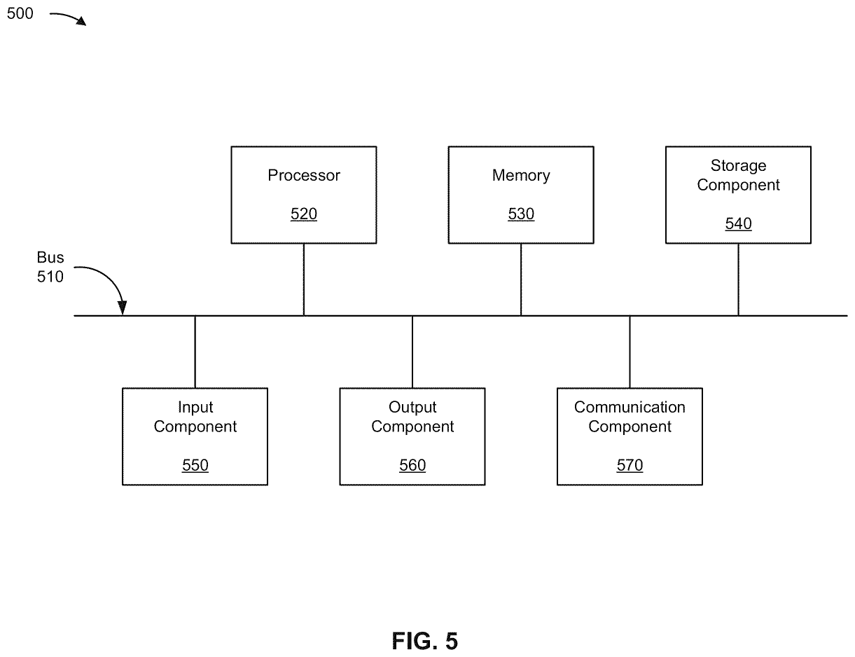

FIG. 5 is a diagram of example components of a device 500, which may implement one or more components of the computing environment 100. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or In some implementations, a set of components (e.g., one or more components) of device 500 may perform one or more functions described as being performed by another set of components of device 500.

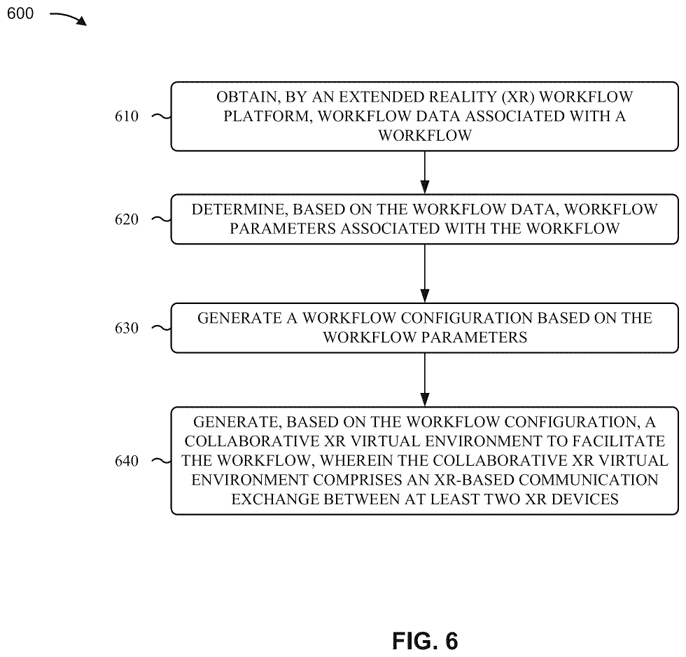

To further describe some implementations in greater detail, reference is next made to examples of techniques which may be performed by or using the XR workflow platform as described herein. FIG. 6 is a flowchart of an example of a technique associated with providing collaborative extended reality virtual environments to facilitate workflows. The technique 600 can be executed using computing devices, such as the systems, hardware, and software described with respect to FIGS. 1A-5. The technique 600 can be performed, for example, by executing a machine-readable program or other computer-executable instructions, such as routines, instructions, programs, or other code. The steps, or operations, of the technique 600, or another technique, method, process, or algorithm described in connection with the implementations disclosed herein can be implemented directly in hardware, firmware, software executed by hardware, circuitry, or a combination thereof.

For simplicity of explanation, the technique 600 is depicted and described herein as a series of steps or operations. However, the steps or operations of the technique 600 can occur in various orders and/or concurrently. Additionally, other steps or operations not presented and described herein may be used. Furthermore, not all illustrated steps or operations may be required to implement a technique in accordance with the disclosed subject matter.

At 610, the technique 600 includes obtaining workflow data associated with a workflow. For example, an XR workflow platform (e.g., the XR workflow platform 114 shown in FIG. 1A) may receive workflow data from an administrator through an administration interface component. In some implementations, the workflow data may be indicative of a set of workflow steps or a set of data parameters associated with the set of workflow steps. The set of data parameters may include at least one of a data source associated with a workflow step, a data dependency associated with the workflow step, or a data schema associated with the workflow step.

At 620, the technique 600 includes determining workflow parameters associated with the workflow based on the workflow data. In some implementations, a workflow configuration component (e.g., the workflow configuration component 118 shown in FIG. 1B) may analyze the workflow data to determine dependencies among steps of the workflow and establish workflow parameters to optimize execution of one or more workflow operations in the collaborative XR virtual environment. The workflow parameters may include parameter values corresponding to at least one of a set of workflow operations, a set of operation dependencies, or a set of security parameters.

At 630, the technique 600 includes generating a workflow configuration based on the workflow parameters. For example, a workflow configuration component (e.g., the workflow configuration component 118 shown in FIG. 1B) may generate a data structure comprising at least one of the workflow parameters, a data processing instruction, a data transfer instruction, a security scheme, or an automation instruction. In some implementations, generating the workflow configuration may involve assigning participants to one or more steps of the workflow based on at least one of a set of participant roles or a set of participant access permissions.

At 640, the technique 600 includes generating a collaborative XR virtual environment based on the workflow configuration to facilitate the workflow. In some implementations, an XR service component (e.g., the XR service component 120 described in relation to FIG. 1C) may create a virtual space that represents the workflow and allows multiple users to interact within it. The collaborative XR virtual environment may comprise an XR-based communication exchange between at least two XR devices.

In some implementations, generating the collaborative XR virtual environment may involve generating at least one avatar representing at least one participant to enable interaction between on-site users and remote user. In some implementations, the process may include establishing a connection between a data source and the XR workflow platform. The data source may comprise at least one of an internal database, an IoT device, a sensor, or an external data source.

In some implementations, generating the workflow configuration may involve dividing the workflow into a first sub-workflow and a second sub-workflow. The technique may then include generating, for the first sub-workflow, a first collaborative XR virtual space within the collaborative XR virtual environment, and generating, for the second sub-workflow, a second collaborative XR virtual space within the collaborative XR virtual environment. In some cases, the technique may further involve dynamically integrating the first collaborative XR virtual space and the second collaborative XR virtual space based on one or more dependencies between the first sub-workflow and the second sub-workflow.

To optimize the division of workflows into sub-workflows, some implementations may include performing a perplexity analysis of a workflow operation associated with the workflow. The perplexity analysis may involve determining an inverse probability of successful completion of a sub-workflow of the first sub-workflow and the second sub-workflow. Based on this analysis, the system may determine the optimal structure for the first sub-workflow and the second sub-workflow.

In some implementations, the technique may include establishing a multimodal communication connection between the at least two XR devices to facilitate the XR-based communication exchange. The multimodal communication connection may comprise at least one of a video communication connection, an audio communication connection, a text communication connection, or a telemetry data connection. This multimodal communication capability can enhance collaboration and information sharing within the XR environment.

Some implementations of the technique may involve transmitting, to one or more robotic components, at least one set of executable instructions to cause the one or more robotic components to execute at least one workflow operation. This integration of XR-based human collaboration with robotic automation can significantly enhance productivity in industries such as manufacturing or logistics.

In certain implementations, generating the collaborative XR virtual environment may include generating a set of collaborative XR virtual spaces, each of which corresponds to a respective workflow step of a set of workflow steps associated with the workflow. This approach allows for a modular and flexible XR environment that can adapt to complex, multi-step workflows with intricate dependencies.

According to an aspect of the disclosure, there is provided a computer-implemented method. The method includes obtaining workflow data associated with a workflow by an extended reality (XR) workflow platform. The method determines workflow parameters associated with the workflow based on the workflow data. The method generates a workflow configuration based on the workflow parameters. The method generates a collaborative XR virtual environment to facilitate the workflow based on the workflow configuration. The collaborative XR virtual environment comprises an XR-based communication exchange between at least two XR devices. This method improves the efficiency of workflow management by integrating real-time data from various sources into a virtual environment. Additionally, the method enhances remote collaboration capabilities by enabling geographically dispersed teams to work together effectively in a shared virtual space.

In embodiments, determining the workflow parameters can include determining dependencies among steps of the workflow and establishing the workflow parameters to optimize execution of one or more workflow operations in the collaborative XR virtual environment. This has the technical effect of improving workflow efficiency by identifying and optimizing critical paths within the workflow. Additionally, this optimization can reduce bottlenecks and improve overall productivity in complex workflows.

In embodiments, generating the workflow configuration can include generating a data structure comprising at least one of the workflow parameters, a data processing instruction, a data transfer instruction, a security scheme, or an automation instruction. This has the technical effect of creating a comprehensive and flexible workflow representation that can adapt to various industrial processes. Additionally, this structured approach to workflow configuration enables easier integration with existing systems and improves scalability.

In embodiments, generating the workflow configuration can include assigning participants to one or more steps of the workflow based on at least one of a set of participant roles or a set of participant access permissions. This has the technical effect of improving security and efficiency by ensuring that only authorized personnel can access specific parts of the workflow. Additionally, this role-based assignment can enhance collaboration by clearly defining responsibilities within the workflow.

In embodiments, generating the collaborative XR virtual environment can include generating at least one avatar representing at least one participant to enable interaction between on-site users and remote users. This has the technical effect of improving communication and collaboration between physically separated team members. Additionally, the use of avatars can enhance the sense of presence and engagement in the virtual environment.

In embodiments, generating the collaborative XR virtual environment can further include establishing a connection between a data source and the XR workflow platform. This has the technical effect of enabling real-time data integration into the virtual environment, allowing for more informed decision-making. Additionally, this connection can improve the accuracy and timeliness of workflow execution.

In embodiments, the data source can comprise at least one of an internal database, an internet-of-things (IoT) device, a sensor, or an external data source. This has the technical effect of providing a wide range of data inputs to enrich the virtual environment and inform workflow processes. Additionally, the integration of diverse data sources can lead to more comprehensive and accurate workflow management.

In embodiments, generating the workflow configuration can include dividing the workflow into a first sub-workflow and a second sub-workflow, generating a first collaborative XR virtual space within the collaborative XR virtual environment for the first sub-workflow, and generating a second collaborative XR virtual space within the collaborative XR virtual environment for the second sub-workflow. This has the technical effect of improving the manageability of complex workflows by breaking them into smaller, more focused components. Additionally, this modular approach can enhance parallel processing and potentially reduce overall workflow completion time.

In embodiments, the method can include dynamically integrating the first collaborative XR virtual space and the second collaborative XR virtual space based on one or more dependencies between the first sub-workflow and the second sub-workflow. This has the technical effect of maintaining overall workflow coherence while allowing for modular execution. Additionally, this dynamic integration can improve flexibility in managing complex, interdependent processes.

In embodiments, the method can include performing a perplexity analysis of a workflow operation associated with the workflow and determining the first sub-workflow and the second sub-workflow based on the perplexity analysis. This has the technical effect of optimizing the division of workflows into sub-workflows, potentially improving overall efficiency. Additionally, this analysis-driven approach can lead to more effective resource allocation and risk management in workflow execution.

In embodiments, performing the perplexity analysis can include determining an inverse probability of successful completion of a sub-workflow of the first sub-workflow and the second sub-workflow. This has the technical effect of quantifying the complexity and risk associated with different workflow components. Additionally, this probabilistic approach can inform decision-making processes and help prioritize resources in workflow management.

According to another aspect of the disclosure, there is provided a computer system. The system includes one or more computer-readable storage media, a processor set, and program instructions stored on the one or more computer-readable storage media to cause the processor set to perform operations. The operations include obtaining workflow data associated with a workflow by an extended reality (XR) workflow platform, determining workflow parameters associated with the workflow based on the workflow data, generating a workflow configuration based on the workflow parameters, and generating a collaborative XR virtual environment to facilitate the workflow based on the workflow configuration. The collaborative XR virtual environment comprises an XR-based communication exchange between at least two XR devices. This system improves the efficiency and flexibility of workflow management by providing a comprehensive platform for creating and executing XR-based workflows. Additionally, the system enhances collaboration and decision-making processes by integrating diverse data sources and enabling real-time interaction in a virtual environment.

In embodiments, the workflow data can be indicative of at least one of a set of workflow steps or a set of data parameters associated with the set of workflow steps. This has the technical effect of providing a structured input for workflow analysis and configuration. Additionally, this detailed workflow data can lead to more accurate and efficient workflow implementations.

In embodiments, the set of data parameters can comprise at least one of a data source associated with a workflow step associated with the workflow, a data dependency associated with the workflow step, or a data schema associated with the workflow step. This has the technical effect of enabling fine-grained control over data flow and processing within the workflow. Additionally, these detailed parameters can improve data integrity and consistency throughout the workflow execution.

In embodiments, the workflow parameters can include parameter values corresponding to at least one of a set of workflow operations, a set of operation dependencies, or a set of security parameters. This has the technical effect of providing a comprehensive representation of workflow requirements and constraints. Additionally, these parameters can enhance workflow optimization and security management.

In embodiments, the operations can further include establishing a multimodal communication connection between the at least two XR devices to facilitate the XR-based communication exchange. This has the technical effect of enabling rich, context-aware communication within the virtual environment. Additionally, this multimodal approach can improve collaboration effectiveness by accommodating different communication preferences and needs.

In embodiments, the multimodal communication connection can comprise at least one of a video communication connection, an audio communication connection, a text communication connection, or a telemetry data connection. This has the technical effect of providing diverse channels for information exchange within the virtual environment. Additionally, these varied communication modes can enhance the flexibility and effectiveness of remote collaboration.

According to another aspect of the disclosure, there is provided a computer program product. The product includes one or more computer-readable storage media and program instructions stored on the one or more computer readable storage media to perform operations. The operations include obtaining workflow data associated with a workflow by an extended reality (XR) workflow platform, determining workflow parameters associated with the workflow based on the workflow data, generating a workflow configuration based on the workflow parameters, and generating a collaborative XR virtual environment to facilitate the workflow based on the workflow configuration. The collaborative XR virtual environment comprises an XR-based communication exchange between at least two XR devices. This product improves the implementation and management of XR-based workflows by providing a software solution that integrates workflow analysis, configuration, and execution in a virtual environment. Additionally, the product enhances the adaptability and scalability of workflow systems across various industries and use cases.

In embodiments, the operations can further include transmitting at least one set of executable instructions to one or more robotic components to cause the one or more robotic components to execute at least one workflow operation. This has the technical effect of integrating physical automation systems with the virtual workflow environment. Additionally, this integration can improve efficiency and safety in industries that combine human and robotic operations.

In embodiments, generating the collaborative XR virtual environment can include generating a set of collaborative XR virtual spaces, each of which corresponds to a respective workflow step of a set of workflow steps associated with the workflow. This has the technical effect of creating a modular and intuitive virtual representation of the workflow process. Additionally, this step-specific approach can improve focus and efficiency by providing tailored virtual environments for each stage of the workflow.

In one implementation, the XR workflow platform is utilized in a manufacturing setting to optimize a complex assembly process for electric vehicles. The system analyzes the workflow data obtained from the production line, including assembly steps, component specifications, and quality control parameters. Based on this analysis, it determines workflow parameters such as optimal sequencing of tasks, resource allocation, and data dependencies between different assembly stations.

The platform then generates a workflow configuration that divides the assembly process into multiple sub-workflows, each corresponding to a major component of the vehicle (e.g., drivetrain, battery pack, interior). For each sub-workflow, the system creates a dedicated collaborative XR virtual space within the larger XR environment. On-site workers, equipped with AR glasses, can see step-by-step assembly instructions overlaid on the physical components they are working with. Simultaneously, remote engineering teams, using VR headsets, can inspect the assembly process in real-time, providing guidance or making adjustments as needed.

The system establishes multimodal communication connections between the on-site and remote teams, enabling seamless collaboration through voice, video, and shared 3D models. For instance, when a quality control issue is detected in the battery pack assembly, the system automatically notifies the relevant engineers. These engineers can then join the specific XR virtual space for the battery pack sub-workflow, examine the issue in detail using high-resolution 3D models, and guide the on-site technicians through the necessary corrective actions.

Throughout the assembly process, the XR workflow platform interfaces with various IoT sensors on the production line, continuously gathering data on factors such as component temperatures, torque applications, and alignment precision. This real-time data is processed and visualized within the XR environment, allowing for immediate detection and resolution of any deviations from the specified assembly parameters.

The system also transmits executable instructions to robotic components involved in the assembly process. For example, when the workflow reaches the stage of applying adhesives for battery cell placement, the XR platform sends precise commands to robotic arms, ensuring optimal application patterns based on the current environmental conditions and specific battery pack configuration.

By implementing this XR-based workflow system, the electric vehicle manufacturer achieves significant improvements in assembly accuracy, reduces production time, and enhances collaboration between on-site and remote teams. The ability to dynamically adjust the workflow based on real-time data and expert input leads to a more agile and efficient manufacturing process, directly addressing the challenges of complex, high-precision assembly operations in the automotive industry.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
obtaining, by an extended reality (XR) workflow platform, workflow data associated with a workflow;
determining, based on the workflow data, workflow parameters associated with the workflow;
generating a workflow configuration based on the workflow parameters; and
generating, based on the workflow configuration, a collaborative XR virtual environment to facilitate the workflow, wherein the collaborative XR virtual environment comprises an XR-based communication exchange between at least two XR devices.

2. The computer-implemented method of claim 1, wherein determining the workflow parameters comprises:
determining dependencies among steps of the workflow; and
establishing the workflow parameters to optimize execution of one or more workflow operations in the collaborative XR virtual environment.

3. The computer-implemented method of claim 1, wherein generating the workflow configuration comprises generating a data structure comprising at least one of the workflow parameters, a data processing instruction, a data transfer instruction, a security scheme, or an automation instruction.

4. The computer-implemented method of claim 1, wherein generating the workflow configuration comprises assigning participants to one or more steps of the workflow based on at least one of a set of participant roles or a set of participant access permissions.

5. The computer-implemented method of claim 1, wherein generating the collaborative XR virtual environment comprises generating at least one avatar representing at least one participant to enable interaction between on-site users and remote users.

6. The computer-implemented method of claim 1, wherein generating the collaborative XR virtual environment further comprises establishing a connection between a data source and the XR workflow platform.

7. The computer-implemented method of claim 6, wherein the data source comprises at least one of an internal database, an internet-of-things (IoT) device, a sensor, or an external data source.

8. The computer-implemented method of claim 1, wherein generating the workflow configuration comprises:
dividing the workflow into a first sub-workflow and a second sub-workflow;
generating, for the first sub-workflow, a first collaborative XR virtual space within the collaborative XR virtual environment; and
generating, for the second sub-workflow, a second collaborative XR virtual space within the collaborative XR virtual environment.

9. The computer-implemented method of claim 8, further comprising dynamically integrating, based on one or more dependencies between the first sub-workflow and the second sub-workflow, the first collaborative XR virtual space and the second collaborative XR virtual space.

10. The computer-implemented method of claim 8, further comprising:
performing a perplexity analysis of a workflow operation associated with the workflow; and
determining, based on the perplexity analysis, the first sub-workflow and the second sub-workflow.

11. The computer-implemented method of claim 10, wherein performing the perplexity analysis comprises determining an inverse probability of successful completion of a sub-workflow of the first sub-workflow and the second sub-workflow.

12. A computer system, comprising:
one or more computer-readable storage media;
a processor set; and
program instructions stored on the one or more computer-readable storage media to cause the processor set to perform operations comprising:
obtaining, by an extended reality (XR) workflow platform, workflow data associated with a workflow;
determining, based on the workflow data, workflow parameters associated with the workflow;
generating a workflow configuration based on the workflow parameters; and
generating, based on the workflow configuration, a collaborative XR virtual environment to facilitate the workflow, wherein the collaborative XR virtual environment comprises an XR-based communication exchange between at least two XR devices.

13. The computer system of claim 12, wherein the workflow data is indicative of at least one of a set of workflow steps or a set of data parameters associated with the set of workflow steps.

14. The computer system of claim 13, wherein the set of data parameters comprises at least one of a data source associated with a workflow step associated with the workflow, a data dependency associated with the workflow step, or a data schema associated with the workflow step.

15. The computer system of claim 12, wherein the workflow parameters include parameter values corresponding to at least one of a set of workflow operations, a set of operation dependencies, or a set of security parameters.

16. The computer system of claim 12, the operations further comprising establishing a multimodal communication connection between the at least two XR devices to facilitate the XR-based communication exchange.

17. The computer system of claim 16, wherein the multimodal communication connection comprises at least one of a video communication connection, an audio communication connection, a text communication connection, or a telemetry data connection.

18. A computer program product comprising:
one or more computer-readable storage media; and
program instructions stored on the one or more computer readable storage media to perform operations comprising:
obtaining, by an extended reality (XR) workflow platform, workflow data associated with a workflow;
determining, based on the workflow data, workflow parameters associated with the workflow;
generating a workflow configuration based on the workflow parameters; and
generating, based on the workflow configuration, a collaborative XR virtual environment to facilitate the workflow, wherein the collaborative XR virtual environment comprises an XR-based communication exchange between at least two XR devices.

19. The computer program product of claim 18, the operations further comprising transmitting, to one or more robotic components, at least one set of executable instructions to cause the one or more robotic components to execute at least one workflow operation.

20. The computer program product of claim 18, wherein generating the collaborative XR virtual environment comprises generating a set of collaborative XR virtual spaces, each of which corresponds to a respective workflow step of a set of workflow steps associated with the workflow.
